(19) United States
(12) Patent Application Publication
(10) Pub. No.: US 2010/0210469 A1
(43) Pub. Date: Aug. 19, 2010

(54) MICROARRAY CHIP AND METHOD FOR DETECTION OF CHROMOSOMAL ABNORMALITY

(75) Inventors: Jason Jongho Kang, Seoul (KR); Eun-Hee Oh, Seoul (KR); Hyun-Wong Kang, Seoul (KR); Jung-Wan Lee, Seoul (KR); Seung-Heui Lee, Seoul (KR); Song-Ju Yang, Seoul (KR); Jeong-Sun Seo, Seoul (KR); Jong-Ho Lee, Seoul (KR); Kap-Seok Yang, Seoul (KR)

Correspondence Address: EDWARDS ANGELL PALMER & DODGE LLP, P.O. BOX 55874, BOSTON, MA, 02205, US

(73) Assignee: MACROGEN INC., Seoul (KR)

(21) Appl. No.: 12/440,397

(22) PCT Filed: Sep. 7, 2007
(86) PCT No.: PCT/KR2007/004345

§ 371 Date: Apr. 20, 2010

(30) Foreign Application Priority Data
Sep. 8, 2006 (US) 60843372

(51) Int. Cl. C40B 30/00; C40B 40/06; C40B 50/14

(52) U.S. Cl. 506/7; 506/16; 506/30

(57) ABSTRACT

The present invention relates to techniques to detect chromosomal columns abnormalities. More specifically, the present invention is directed to a microarray chip for detecting chromosomal abnormalities comprising one or more pooled probe sets, wherein the pooled probe set is specific to a chromosomal abnormality and all probes of each pooled probe set are immobilized together in at least one spot; a method of detecting chromosomal abnormalities using the microarray chip; a kit for diagnosing diseases associated with chromosomal abnormalities comprising the microarray chip; and a method of diagnosing a disease associated with a chromosomal abnormality by identifying the chromosomal abnormality specific to the disease using the microarray chip. The present invention relates to techniques to detect chromosomal abnormalities. More specifically, the present invention is directed to a microarray chip for detecting chromosomal abnormalities comprising one or more pooled probe sets, wherein the pooled probe set is specific to a chromosomal abnormality and all probes of each pooled probe set are immobilized together in at least one spot; a method of detecting chromosomal abnormalities using the microarray chip; a kit for diagnosing diseases associated with chromosomal abnormalities comprising the microarray chip; and a method of diagnosing a disease associated with a chromosomal abnormality by identifying the chromosomal abnormality specific to the disease using the microarray chip.

### CROSS REFERENCE TO RELATED APPLICATION

This application claims priority to and the benefit of U.S. Provisional Application No. 60/843,372 filed on Sep. 8, 2006, which is hereby incorporated by reference for all purposes as if fully set forth herein.

### BACKGROUND OF THE INVENTION

(a) Field of the Invention

The present invention relates to techniques to detect chromosomal abnormalities. More specifically, the present invention is directed to a microarray chip for detecting chromosomal abnormalities comprising one or more pooled probe sets, wherein the pooled probe set is specific to a chromosomal abnormality and all probes of each pooled probe set are immobilized together in at least one spot; a method of detecting chromosomal abnormalities using the microarray chip; a kit for diagnosing diseases associated with chromosomal abnormalities comprising the microarray chip; and a method of diagnosing a disease associated with a chromosomal abnormality by identifying the chromosomal abnormality specific to the disease using the microarray chip.

(b) Description of the Related Art

Chromosomal abnormality is associated with genetic defect and degenerative disease. The chromosomal abnormality can be a deletion or duplication of a chromosome, a deletion or duplication of a part of chromosome, or a break, translocation, or inversion in the chromosome. The chromosomal abnormality is a disturbance in the genetic balance and causes fetal death or serious defect in physical and mental states. For examples, Down's syndrome is a common abnormality of chromosome number caused by the presence of a third chromosome 21 (trisomy 21). Edwards syndrome (trisomy 18), Patau syndrome (trisomy 13), Turner syndrome (XO) and Klinefelter syndrome (XXY) also belong to abnormalities in chromosome number.

The chromosomal abnormality can be detected by using Karyotype, and Fluorescent In Situ Hybridization (FISH). These detection methods have disadvantages in terms of time, labor and accuracy. Moreover, the Karyotype requires much time in cell culture. FISH can only be used for samples where the nucleic acid sequence and chromosomal location are known. Comparative genome hybridization (CGH) can be used to avoid problems of FISH. CGH can analyze a whole genome to detect the part where chromosome number abnormality occurs. However, the disadvantage of CGH has a low resolution compared to FISH.

In a different approach, DNA microarrays can be used for detecting the chromosomal abnormality. DNA microarray systems may be classified into cDNA microarrays, oligonucleotide microarrays, and genome microarrays, depending upon the kinds of the bio-molecules immobilized on the microarray. Even though cDNA microarrays and oligonucleotide microarrays are easily prepared, the systems have the disadvantages of the limitation in the number of probes immobilized on the microarray, high cost of probe preparation, and difficulty in detecting a chromosomal abnormality located external to the probe. In particular, for genomic DNA microarray systems, although the probe can be easily made, and can detect chromosomal abnormalities in the expansive area of the chromosome, and also in intron areas of the chromosome, it is difficult to prepare a large number of DNA fragments where the chromosomal location and function are identified.

Therefore, it has been required to develop techniques to easily detect chromosomal abnormalities with high performance.

### SUMMARY OF THE INVENTION

In one embodiment, the present invention provides a microarray chip for detecting chromosomal abnormality comprising one or more pooled probe sets, wherein each pooled probe set is specific to a chromosomal abnormality and immobilized in one spot.

In another embodiment, the present invention provides a method of preparing the microarray chip comprising the step of immobilizing one or more pooled probe sets in spots on a substrate, wherein each pooled probe set is specific to a chromosomal abnormality, and immobilized in one spot.

In yet another embodiment, the present invention provides a method of detecting chromosomal abnormalities using the microarray chip.

In yet another embodiment, the present invention provides a kit for diagnosing a disease associated with a chromosomal abnormality, comprising the microarray chip.

In yet another embodiment, the present invention provides a method of diagnosing a disease associated with a chromosomal abnormality using the microarray chip.

The disease diagnosable by the present invention may be one or more selected from the group consisting of Down syndrome, Patau syndrome, Edward syndrome, Tuner syndrome, Klinefelter syndrome, Super female syndrome, Super male syndrome, Wolf-Hirschhorn syndrome, Cri-Du-Chat syndrome, William syndrome, Prader-willi syndrome, Angelman syndrome, Miller-Dieker Lissencephaly syndrome, Smith-Magenis syndrome, Digeorge syndrome, Steroid Sulfatase deficiency, and the like.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawing, wherein:

FIG. 1 is a schematic view illustrating the present microarray according to an embodiment.

FIG. 2 exemplarily shows pooling of BAC clones to generate pooled Chromosome 1 probe set.

FIG. 3 shows the regions (orange color) used as controls in Example 2.5.

FIG. 4 shows the FISH result using Chromosome 13 as target and #626(13q12.1) as control in Example 2.5.

FIG. 5 shows the FISH result using Chromosome 13 as target and Cen. 7 as control in Example 2.5.

FIG. 6 shows the FISH result using Chromosome 21 as target and #88(21q11.2) as control in Example 2.5.

FIG. 7 shows the FISH result using Chromosome 21 as target and Cen. 7 as control in Example 2.5.

FIG. 8 shows the FISH result using Chromosome X as target and Cen. X as control in Example 2.5.

FIG. 9 shows the results of λHindIII Marker Separation in 1% agarose gel, wherein the numbers indicated at right of the column correspond to those of Table 39.

FIG. 10 schematically shows the detection processes of the present invention.

FIGS. 11A and 11B show the results obtained in Example 3.

### DETAILED DESCRIPTION OF THE PREFERRED EMBODIMENTS

A more complete appreciation of the invention, and many of the attendant advantages thereof, will be readily apparent as the same becomes better understood by reference to the following detailed description.

In one aspect, the present invention relates to a microarray chip for detecting chromosomal abnormality comprising one or more pooled probe sets, wherein each pooled probe set is specific to a chromosomal abnormality and immobilized in one or more spots.

In the present invention, the chromosomal abnormality may include aberrations in copy number of chromosome associated with aneuploidy of one or more Chromosomes 1 to 22, X and Y, or quantitative aberrations caused by micro-deletion or micro-duplication of a specific chromosomal region. Generally, such chromosomal abnormality in chromosomal copy number and/or a specific chromosomal region is associated with various diseases. The representative examples of such chromosomal abnormality-associated diseases are summarized in following Table 1.

TABLE 1

| | Chromosomal abnormality | |
|---|---|---|
| Disease | (Karyotype) | Incidence |
| Down Syndrome | 2n = 47 (trisomy 21) | 1/770 |
| Patau Syndrome | 2n = 47 (trisomy 13) | 1/15,000 |
| Edward Syndrome | 2n = 47 (trisomy 18) | 1/4,000~1/8,000 |
| Tuner Syndrome | 2n = 45 (XO) | 1/10,000 females |
| Klinefelter Syndrome | 2n = 47 (XXY) | 1/1000 males |
| Super female syndrome | 2n = 47 (XXX) | 1/1000 females |
| Super male syndrome | 2n = 47 (XYY) | 1/1000 males |
| Wolf-Hirschhorn syndrome (WHS) | 4p16.3 deletion | 1/30,000~1/50,000 |
| Cri-Du-Chat syndrome | 5p15.2 deletion | 1/30,000~1/50,000 |
| William syndrome (WBS) | 7q11.2 deletion | 1/7,500~1/20,000 |
| Prader-willi syndrome (PWS) | 15q11-15q13 deletion (paternal) | 1/10,000~1/15,000 |
| Angelman syndrome (AS) | 15q11-15q13 deletion(maternal) | 1/15,000~1/30,000 |
| Miller-Dieker Lissencephaly syndrome | 17p13.3 deletion | 1/100,000 |
| (MDLS) | | |
| Smith-Magenis syndrome (SMS) | 17p11.2 deletion | 1/25,000 |
| Digeorge syndrome (DGS) | 22q11.2 deletion | 1/4,000~1/6,000 |
| Steroid Sulfatase deficiency syndrome | Xp22.31 deletion | 1/2,000~1/6,000 males |
| (STS) | | |

As used herein, the term ‘probe’ refers to a nucleic acid fragment which is immobilized on a microarray and capable of hybridizing with a homologous DNA in a test sample or reference. The probe can be DNA, RNA, cDNA or mRNA, or oligomer DNA. Preferably, the probe has a single chromosomal locus.

In an embodiment of the present invention, the probes may be selected from Bacterial Artificial Chromosome (BAC) clones. The BAC clones include BAC vectors containing a certain size fragment of the whole human genome. Because a BAC clone includes one fragment of a human DNA, the BAC clone corresponding to a specific part of a chromosome can be arrayed by analyzing the nucleic acid sequence and chromosomal location of the inserted DNA. Thus, specific DNA fragments can be easily obtained from each BAC clone.

As used herein, the term ‘pooled probe set’ refers to a mixture of probes, preferably, in equal amounts, wherein the probes are specifically selected from the whole genome DNA, preferably human genome, as representing each chromosome or a specific chromosomal region and being capable of specifically detecting the genetic status thereof, such as, the copy number change, micro-deletion, micro-amplification, and the like. In the present invention, 32 pooled probe sets are identified for Chromosomes 1 to 22, X and Y, and several chromosomal regions associated with micro-deletion, respectively.

The most important feature of the present invention resides in that several probes representing a chromosome or a chromosomal region are specifically selected and pooled for each chromosome or chromosomal region, for the use in detecting a specific chromosomal abnormality, to achieve a rapid, convenient and accurate detection.

As described above, the pooled probe sets of the present invention are specifically selected for a specific type of chromosomal abnormality, and thus, specifically related to the chromosomal abnormality-associated disease.

The pooled probe set may be one or more selected form the group consisting of:

a pooled probe set (pooled probe set 1) specific to the chromosomal abnormality in copy number of Chromosome 1 consisting essentially of human chromosomal polynucleotides carried in BAC27_N16, BAC25_C19, BAC153_I07, BAC217_C19, BAC59_D13, BAC54_I02, BAC163_C09, BAC218_G03, BAC152_F22, BAC34P03, BAC36_I16, BAC145_L11, BAC37_O23, BAC239_G19, BAC105_P13, BAC57_N17, BAC239_A12, BAC171_H09, and BAC222 E02;

a pooled probe set (pooled probe set 2) specific to the chromosomal abnormality in copy number of Chromosome 2 consisting essentially of human chromosomal polynucleotides carried in BAC126_E04, BAC197_E10, BAC43_A02, BAC33_C05, BAC59_D21, BAC12_G01, BAC141_F07, BAC163_C22, BAC36_H22, BAC143_G24, BAC238_G01, BAC252_A16, BAC46_J12, BAC57_C12, BAC34_F17, BAC79_L21, BAC39_M07, BAC156_K09, BAC195_{—}106, and BAC88_K20;

a pooled probe set (pooled probe set 3) specific to the chromosomal abnormality in copy number of Chromosome 3 consisting essentially of human chromosomal polynucleotides carried in BAC197_B21, BAC158_C03, BAC144_C11, BAC186_N05, BAC103_F06, BAC114_B23, BAC102_E23, BAC119_G21, BAC68_H20, BAC237_M11, BAC168_G04, BAC61_M02, and BAC36_N19;

a pooled probe set (pooled probe set 4) specific to the chromosomal abnormality in copy number of Chromosome 4 consisting essentially of human chromosomal polynucleotides carried in BAC60_H08, BAC26_C10, BAC68_O19, BAC102_G08, BAC127_B16, BAC176_G14, BAC41_O05, BAC37_H04, BAC115_C13, BAC30_N21, BAC220_D24, BAC106_P17, BAC41_O11, BAC157_P10, and BAC27_L15;

a pooled probe set (pooled probe set 5) specific to the chromosomal abnormality in copy number of Chromosome 5 consisting essentially of human chromosomal polynucleotides carried in BAC86_B20, BAC33_N18, BAC55_L24, BAC226_H03, BAC156_E24, BAC237_B02, BAC29_D17, BAC139_M23, BAC21_J16, BAC27_N23, BAC148_D23, BAC186L21, BAC238_E21, and BAC175_N07;

a pooled probe set (pooled probe set 6) specific to the chromosomal abnormality in copy number of Chromosome 6 consisting essentially of human chromosomal polynucleotides carried in BAC125_G09, BAC182_E20, BAC81_C08, BAC24_P12, BAC76_A23, BAC26_F16, BAC43_M14, BAC27_P17, BAC1_N23, BAC247_D17, BAC101_M04, BAC90_F08, BAC118_M18, and BAC179_N12;

a pooled probe set (pooled probe set 7) specific to the chromosomal abnormality in copy number of Chromosome 7 consisting essentially of human chromosomal polynucleotides carried in BAC231_L03, BAC82_L17, BAC218_N01, BAC5_A09, BAC170_M16, BAC119_K16, BAC248_P06, BAC96_F02, BAC139_J04, BAC76_K13, BAC192_N04, BAC154_A21, and BAC120_I09;

a pooled probe set (pooled probe set 8) specific to the chromosomal abnormality in copy number of Chromosome 8 consisting essentially of human chromosomal polynucleotides carried in BAC150_M15, BAC149_J08, BAC63_M21, BAC147_O15, BAC44_I16, BAC30_N24, BAC43_J01, BAC234_M17, BAC68_K11, BAC200_C08, BAC237_M08, BAC61_N10, BAC80_H19, BAC150_P12, and BAC66_I02;

a pooled probe set (pooled probe set 9) specific to the chromosomal abnormality in copy number of Chromosome 9 consisting essentially of human chromosomal polynucleotides carried in BAC80_F23, BAC28_L14, BAC137_L16, BAC161_C10, BAC92_D01, BAC163_H11, BAC12_E22, BAC172_D10, BAC149_L08, BAC188_O18, and BAC126_N07;

a pooled probe set (pooled probe set 10) specific to the chromosomal abnormality in copy number of Chromosome 10 consisting essentially of human chromosomal polynucleotides carried in BAC 170_F05, BAC102_J19, BAC40_P04, BAC141_E23, BAC246_I22, BAC14_K16, BAC52_B14, BAC158_C10, BAC155_O18, BAC144_E19, BAC218_E11, BAC48_I12, and BAC182_N07;

a pooled probe set (pooled probe set 11) specific to the chromosomal abnormality in copy number of Chromosome 11 consisting essentially of human chromosomal polynucleotides carried in BAC68_K10, BAC90_E18, BAC24_K17, BAC58_O19, BAC36_K05, BAC150_P20, BAC154_H22, BAC26_C09, BAC119_O13, BAC195_O14, BAC73_E17, BAC142_K09, and BAC65_D19;

a pooled probe set (pooled probe set 12) specific to the chromosomal abnormality in copy number of Chromosome 12 consisting essentially of human chromosomal polynucleotides carried in BAC60_I23, BAC121_P21, BAC199_G02, BAC65_G10, BAC41_I18, BAC10_M07, BAC39_O14, BAC144_K11, BAC178_M15, BAC134_M17, BAC65_I21, and BAC27_E08;

a pooled probe set specific (pooled probe set 13) to the chromosomal abnormality in copy number of Chromosome 13 consisting essentially of human chromosomal polynucleotides carried in BAC28_H21, BAC163_F01, BAC78_C21, BAC135_O03, BAC237_P24, BAC84_N09, BAC8_C18, BAC133_G23, and BAC116_B15;

a pooled probe set (pooled probe set 14) specific to the chromosomal abnormality in copy number of Chromosome 14 consisting essentially of human chromosomal polynucleotides carried in BAC236_F24, BAC22_E01, BAC37_K09, BAC79_J20, BAC50_I09, BAC15_E12, BAC63_O11, BAC11_N10, BAC39_P02, and BAC101_O15;

a pooled probe set (pooled probe set 15) specific to the chromosomal abnormality in copy number of Chromosome 15 consisting essentially of human chromosomal polynucleotides carried in BAC66_K21, BAC162_K11, BAC178_K16, BAC21_K13, BAC167_M02, BAC88_F18, BAC168_F12, BAC10_E08, BAC177_H09, and BAC41_K03;

a pooled probe set (pooled probe set 16) specific to the chromosomal abnormality in copy number of Chromosome 16 consisting essentially of BAC38_I04, BAC96_J19, BAC120_K24, BAC177_P23, BAC247_B03, BAC117_H14, BAC96_G02, BAC24_D17, and BAC223_D19;

a pooled probe set (pooled probe set 17) specific to the chromosomal abnormality in copy number of Chromosome 17 consisting essentially of human chromosomal polynucleotides carried in BAC200_M05, BAC50_A03, BAC149_H11, BAC29_G13, BAC238_E06, BAC150_O15, BAC70_P11, BAC70_N11, BAC116_E10, and BAC48_K14;

a pooled probe set (pooled probe set 18) specific to the chromosomal abnormality in copy number of Chromosome 18 consisting essentially of human chromosomal polynucleotides carried in BAC57_H08, BAC141_I04, BAC252_H16, BAC232_E19, BAC149_I18, BAC186_P19, BAC151_L02, BAC230_C11, BAC43_A24, and BAC184_J04;

a pooled probe set (pooled probe set 19) specific to the chromosomal abnormality in copy number of Chromosome 19 consisting essentially of human chromosomal polynucleotides carried in BAC178_L22, BAC160_C11, BAC131_N13, BAC54_N22, BAC233_K14, BAC162_K04, BAC76_E22, BAC211_B15, BAC101_H02, and BAC193_C07;

a pooled probe set (pooled probe set 20) specific to the chromosomal abnormality in copy number of Chromosome 20 consisting essentially of human chromosomal polynucleotides carried in BAC247_K09, BAC26_J24, BAC75_H16, BAC37_M13, BAC19_G17, BAC82_B07, BAC96_H08, BAC166_J02, BAC41_E11, and BAC146_N07;

a pooled probe set (pooled probe set 21) specific to the chromosomal abnormality in copy number of Chromosome 21 consisting essentially of human chromosomal polynucleotides carried in BAC102_F10, BAC240_M07, BAC200_O02, BAC97_O19, BAC119_K07, BAC200_A23, BAC221_D22, BAC100_D11, BAC33_D15, and BAC126_M10;

a pooled probe set (pooled probe set 22) specific to the chromosomal abnormality in copy number of Chromosome 22 consisting essentially of human chromosomal polynucleotides carried in BAC169_G07, BAC153_I19, BAC100_P10, BAC37_J03, BAC187_K08, BAC131_H09, BAC106_C07, BAC66_M06, BAC51_M21, and BAC153_O04;

a pooled probe set (pooled probe set 23) specific to the chromosomal abnormality in copy number of Chromosome X consisting essentially of human chromosomal polynucleotides carried in BAC70_N16, BAC22_H14, BAC65_L14, BAC151_A03, BAC49_G05, BAC130_K20, BAC103_N15, BAC136_M01, BAC6_B17, BAC141_P03, BAC246_K02, BAC91_J24, BAC97_C11, BAC63_G23, BAC73_B07, BAC162_B10, and BAC119_C15;

a pooled probe set (pooled probe set 24) specific to the chromosomal abnormality in copy number of Chromosome Y consisting essentially of human chromosomal polynucleotides carried in BAC24_K23, BAC205_L13, BAC127_H21, BAC192_M14, BAC101_I21, BAC140_H17, BAC65_J16, BAC180_K16, BAC102_F03, BAC31_L01, and BAC240_H05;

a pooled probe set (pooled probe set 25) specific to micro-deletion of 4p16.3 of Chromosome 4 consisting essentially of human chromosomal polynucleotides carried in BAC50_H08, BAC67_I12, BAC100_E03, BAC1_F06, BAC135_O20, and BAC153_J14;

a pooled probe set (pooled probe set 26) specific to micro-deletion of 5p15.2 of Chromosome 5 consisting essentially of human chromosomal polynucleotides carried in BAC143_N22, BAC206_I13, BAC252_N08, BAC64_P22, BAC208_N21, BAC200_E05, and BAC240_K06;

a pooled probe set (pooled probe set 27) specific to micro-deletion of 7q11.2 of Chromosome 7 consisting essentially of human chromosomal polynucleotides carried in BAC69_O08, BAC66_N22, BAC180_N24, BAC67_C05, BAC183_A12, and BAC123_D05;

a pooled probe set (pooled probe set 28) specific to micro-deletion of 15q11-15q13 of Chromosome 15 consisting essentially of human chromosomal polynucleotides carried in BAC188_N24, BAC223_H02, BAC217_F02, BAC71_A18, BAC5_L18, BAC248_C13, BAC78_F07, BAC180_J22, BAC21_O06, and BAC105_L07;

a pooled probe set (pooled probe set 29) specific to micro-deletion of 17p13.3 of Chromosome 17 consisting essentially of human chromosomal polynucleotides carried in BAC95_J10, BAC75_C17, BAC110_O13, BAC63_J08, BAC190_F10, BAC186_M15, BAC183_M06, BAC135_N07, BAC_F06, and BAC31_H03;

a pooled probe set (pooled probe set 30) specific to micro-deletion of 17p11.2 of Chromosome 17 consisting essentially of human chromosomal polynucleotides carried in BAC249_G12, BAC41_D18, and BAC186_E14;

a pooled probe set (pooled probe set 31) specific to micro-deletion of 22q11.2 of Chromosome 22 consisting essentially of human chromosomal polynucleotides carried in BAC124_E21, BAC196_A22, BAC69_P21, BAC141_K20, BAC169_K21, BAC145_P12, and BAC224_F10; and

a pooled probe set (pooled probe set 32) specific to micro-deletion of Xp22.31 of Chromosome X consisting essentially of human chromosomal polynucleotides carried in BAC221_A12, BAC191_E24, and BAC231_F19.

In an embodiment, the present invention relates to a microarray chip comprising one or more pooled probe sets selected from pooled probe sets 1 to 24 to detect any chromosomal abnormality in copy number of Chromosomes 1 to 22, X and Y corresponding to the used pooled probe set.

More specifically, the present invention may relate to a microarray chip comprising pooled probe set 1 to detect chromosomal abnormality in copy number of Chromosome 1. The present invention may relate to a microarray chip comprising pooled probe set 2 to detect chromosomal abnormality in copy number of Chromosome 2. The present invention may relate to a microarray chip comprising pooled probe set 3 to detect chromosomal abnormality in copy number of Chromosome 3. The present invention may relate to a microarray chip comprising pooled probe set 4 to detect chromosomal abnormality in copy number of Chromosome 4. The present invention may relate to a microarray chip comprising pooled probe set 5 to detect chromosomal abnormality in copy number of Chromosome 5. The present invention may relate to a microarray chip comprising pooled probe set 6 to detect chromosomal abnormality in copy number of Chromosome 6. The present invention may relate to a microarray chip comprising pooled probe set 7 to detect chromosomal abnormality in copy number of Chromosome 7. The present invention may relate to a microarray chip comprising pooled probe set 8 to detect chromosomal abnormality in copy number of Chromosome 8. The present invention may relate to a microarray chip comprising pooled probe set 9 to detect chromosomal abnormality in copy number of Chromosome 9. The present invention may relate to a microarray chip comprising pooled probe set 10 to detect chromosomal abnormality in copy number of Chromosome 10. The present invention may relate to a microarray chip comprising pooled probe set 11 to detect chromosomal abnormality in copy number of Chromosome 11. The present invention may relate to a microarray chip comprising pooled probe set 12 to detect chromosomal abnormality in copy number of Chromosome 12. The present invention may relate to a microarray chip comprising pooled probe set 13 to detect chromosomal abnormality in copy number of Chromosome 13. The present invention may relate to a microarray chip comprising pooled probe set 14 to detect chromosomal abnormality in copy number of Chromosome 14. The present invention may relate to a microarray chip comprising pooled probe set 15 to detect chromosomal abnormality in copy number of Chromosome 15. The present invention may relate to a microarray chip comprising pooled probe set 16 to detect chromosomal abnormality in copy number of Chromosome 16. The present invention may relate to a microarray chip comprising pooled probe set 17 to detect chromosomal abnormality in copy number of Chromosome 17. The present invention may relate to a microarray chip comprising pooled probe set 18 to detect chromosomal abnormality in copy number of Chromosome 18. The present invention may relate to a microarray chip comprising pooled probe set 19 to detect chromosomal abnormality in copy number of Chromosome 19. The present invention may relate to a microarray chip comprising pooled probe set 20 to detect chromosomal abnormality in copy number of Chromosome 20. The present invention may relate to a microarray chip comprising pooled probe set 21 to detect chromosomal abnormality in copy number of Chromosome 21. The present invention may relate to a microarray chip comprising pooled probe set 22 to detect chromosomal abnormality in copy number of Chromosome 22. The present invention may relate to a microarray chip comprising pooled probe set 23 to detect chromosomal abnormality in copy number of Chromosome X. The present invention may relate to a microarray chip comprising pooled probe set 24 to detect chromosomal abnormality in copy number of Chromosome Y. The present invention may relate to a microarray chip comprising pooled probe sets 1 to 24 to detect chromosomal abnormalities in copy numbers of the whole chromosomes.

In another embodiment, the present invention relates to a microarray chip comprising one or more pooled probe sets selected from the group consisting of pooled probe sets 25 to 32 to detect micro-deletion of specific chromosomal regions corresponding to the used pooled probe set. More specifically, the present invention may relate to a microarray chip comprising pooled probe set 25 to detect micro-deletion of 4p16.3 of Chromosome 4. The present invention may relate to a microarray chip comprising pooled probe set 26 to detect micro-deletion of 5p15.2 of Chromosome 5. The present invention may relate to a microarray chip comprising pooled probe set 27 to detect micro-deletion of 7q11.2 of Chromosome 7. The present invention may relate to a microarray chip comprising pooled probe set 28 to detect micro-deletion of 15q11-15q13 of Chromosome 15. The present invention may relate to a microarray chip comprising pooled probe set 29 to detect micro-deletion of 17p13.3 of Chromosome 17. The present invention may relate to a microarray chip comprising pooled probe set 30 to detect micro-deletion of 17p11.2 of Chromosome 17. The present invention may relate to a microarray chip comprising pooled probe set 31 to detect micro-deletion of 22q11.2 of Chromosome 22. The present invention may relate to a microarray chip comprising pooled probe set 32 to detect micro-deletion of Xp22.31 of Chromosome X. The present invention may relate to a microarray chip comprising pooled probe sets 25 to 32 to detect micro-deletions in specific chromosomal regions associated with Wolf-Hirschhorn, Cri-Du-Chat, William, Prader-willi, Angelman, Miller-Dieker Lissencephaly, Smith-Magenis, Digeorge, or Steroid Sulfatase Deficiency syndrome.

In another embodiment, the microarray chip may comprise pooled probe sets 1 to 24, and further comprise one or more pooled probe sets selected from the group consisting of pooled probe sets 25 to 32 to simultaneously detect chromosomal abnormality in copy number and micro-deletion of a specific chromosomal region.

In an embodiment of the present invention, all probes belonging to each pooled probe set are mixed and immobilized in a spot on the substrate, one spot comprises only one pooled probe set, and the microarray chip may comprise at least one spot for each pooled probe set. The number of the spots for each pooled probe set may be properly adjusted by considering the intended use and purpose, the total number of the used pooled primer sets, the total area of the chip, and the like, preferably 1- to 20-fold, more preferably 1- to 10-fold, but not limited thereto. The concentration of the immobilized pooled probe set may be 2 to100 pg per a spot. The shape of spot may be circular with 50 to 500 um of diameter, and the interval between the centers of the two adjacent spots may be more than the sum of the radiuses of the two spots, preferably 10 to 1000 um, but not limited thereto. The size and density of spot can be adjusted suitably depending upon the intended resolution of the analyzing system for the microarray.

The substrate of the microarray chip may be any one which is widely used in the art. Preferably, the substrate may have a functional group for immobilizing the probe on its surface, or be made from material being capable of forming three-dimensional structure. For example, the substrate may be made one or more materials selected from the group consisting of silicone wafer, glass, polycarbonate, nitrocellulose or nylon membrane, polymer films such as polystyrene or polyurethane, and porous materials.

The pooled probe sets 1 to 32 are summarized in following Tables 2 to 33, respectively.

TABLE 2
A pooled probe set specific to detecting chromosomal abnormality
in copy number of Chromosome 1 (Pooled probe set 1).

| Bac_ID | Chr. No. | Cyto | Bac_start | Bac_end | Bac_size | Repeat % | Megablast |
|---|---|---|---|---|---|---|---|
| BAC27_N16 | 1 | 1p36.13 | 19285054 | 19395702 | 110648 | 27.05 | perfect |
| BAC25_C19 | 1 | 1p34.3 | 37170820 | 37285410 | 114590 | 27.03 | perfect |
| BAC153_I07 | 1 | 1p32.3 | 54534001 | 54652201 | 118200 | 25.17 | perfect |
| BAC217_C19 | 1 | 1p31.3 | 66822471 | 66925991 | 103520 | 29.12 | perfect |
| BAC59_D13 | 1 | 1p31.1 | 82036545 | 82127504 | 90959 | 16.89 | perfect |
| BAC54_I02 | 1 | 1p22.2 | 88351055 | 88477939 | 126884 | 27.41 | perfect |
| BAC163_C09 | 1 | 1p21.3 | 98212449 | 98304737 | 92288 | 19.25 | perfect |
| BAC218_G03 | 1 | 1p13.3 | 110490903 | 110607934 | 117031 | 28.98 | perfect |
| BAC152_F22 | 1 | 1p12 | 117910281 | 118017185 | 106904 | 31.56 | perfect |
| BAC34_P03 | 1 | 1q21.1 | 145406431 | 145498341 | 91910 | 40.7 | perfect |
| BAC36_I16 | 1 | 1q22 | 154638024 | 154757662 | 119638 | 28.64 | perfect |
| BAC145_L11 | 1 | 1q23.3 | 162863145 | 162984456 | 121311 | 18.36 | perfect |
| BAC37_O23 | 1 | 1q25.1 | 173728216 | 173843014 | 114798 | 27.28 | perfect |
| BAC239_G19 | 1 | 1q25.3 | 182629151 | 182749008 | 119857 | 34.15 | perfect |
| BAC105_P13 | 1 | 1q31.3 | 197091253 | 197202904 | 111651 | 29.21 | perfect |
| BAC57_N17 | 1 | 1q41 | 212185136 | 212282511 | 97375 | 12.14 | perfect |
| BAC239_A12 | 1 | 1q42.2 | 230646993 | 230768530 | 121537 | 23.07 | perfect |
| BAC171_H09 | 1 | 1q43 | 237712318 | 237831818 | 119500 | 37.74 | perfect |
| BAC222_E02 | 1 | 1q43- | 241619770 | 241732398 | 112628 | 25.61 | perfect |
| | | 1q44 | | | | | |

TABLE 3
A pooled probe set specific to detecting chromosomal abnormality
in copy number of Chromosome 2 (Pooled probe set 2).

| Bac_ID | Chr. No. | Cyto | Bac_start | Bac_end | Bac_size | Repeat % | Megablast |
|---|---|---|---|---|---|---|---|
| BAC126_E04 | 2 | 2p24.1 | 23602292 | 23712473 | 110181 | 26.88 | perfect |
| BAC197_E10 | 2 | 2p23.3 | 27095066 | 27214934 | 119868 | 34.22 | perfect |
| BAC43_A02 | 2 | 2p22.2 | 36561484 | 36662948 | 101464 | 20.26 | perfect |
| BAC33_C05 | 2 | 2p21 | 47070526 | 47183203 | 112677 | 24.72 | perfect |
| BAC59_D21 | 2 | 2p16.2 | 54644967 | 54759707 | 114740 | 17.3 | perfect |
| BAC12_G01 | 2 | 2p14 | 66500267 | 66617870 | 117603 | 14.47 | perfect |
| BAC141_F07 | 2 | 2p12 | 80058556 | 80173059 | 114503 | 30.95 | perfect |
| BAC163_C22 | 2 | 2q11.2 | 98459189 | 98579536 | 120347 | 26.6 | cutoff |
| BAC36_H22 | 2 | 2q12.1 | 104773145 | 104878334 | 105189 | 19.15 | perfect |
| BAC143_G24 | 2 | 2q14.2 | 119233409 | 119344014 | 110605 | 23.45 | perfect |
| BAC238_G01 | 2 | 2q21.3 | 134822967 | 134934479 | 111512 | 24.36 | perfect |
| BAC252_A16 | 2 | 2q22.3 | 144992590 | 145107231 | 114641 | 25.6 | perfect |
| BAC46_J12 | 2 | 2q23.3 | 152925448 | 153050963 | 125515 | 27.5 | perfect |
| BAC57_C12 | 2 | 2q24.2 | 162502518 | 162618183 | 115665 | 21.69 | perfect |
| BAC34_F17 | 2 | 2q31.1 | 176602023 | 176707880 | 105857 | 23.81 | perfect |
| BAC79_L21 | 2 | 2q32.1 | 188831021 | 188946517 | 115496 | 38.48 | cutoff |
| BAC39_M07 | 2 | 2q33.1 | 199897389 | 200006981 | 109592 | 23.1 | perfect |
| BAC156_K09 | 2 | 2q34 | 213472534 | 213593503 | 120969 | 23.99 | perfect |
| BAC195_I06 | 2 | 2q36.3 | 227821772 | 227932448 | 110676 | 31.33 | cutoff |
| BAC88_K20 | 2 | 2q37.2 | 235531135 | 235632693 | 101558 | 24.89 | perfect |

TABLE 4
A pooled probe set specific to detecting chromosomal abnormality
in copy number of Chromosome 3 (Pooled probe set 3).

| Bac_ID | Chr. No. | Cyto | Bac_start | Bac_end | Bac_size | Repeat % | Megablast |
|---|---|---|---|---|---|---|---|
| BAC197_B21 | 3 | 3p26.1 | 7619617 | 7724613 | 104996 | 27.53 | perfect |
| BAC158_C03 | 3 | 3p24.2 | 25484129 | 25595025 | 110896 | 28.09 | perfect |
| BAC144_C11 | 3 | 3p22.3 | 35638825 | 35740337 | 101512 | 14.74 | perfect |
| BAC186_N05 | 3 | 3p21.1 | 53696599 | 53834500 | 137901 | 17.93 | perfect |
| BAC103_F06 | 3 | 3p14.2 | 62398546 | 62502148 | 103602 | 21.41 | perfect |
| BAC114_B23 | 3 | 3p13 | 73635347 | 73736476 | 101129 | 25.76 | perfect |
| BAC102_E23 | 3 | 3p12.1 | 85609865 | 85716578 | 106713 | 27.09 | cutoff |
| BAC119_G21 | 3 | 3q12.1 | 101052953 | 101162681 | 109728 | 27.18 | perfect |
| BAC68_H20 | 3 | 3q21.3 | 128151883 | 128252811 | 100928 | 21.7 | perfect |
| BAC237_M11 | 3 | 3q22.3 | 138963565 | 139067350 | 103785 | 37.46 | perfect |
| BAC168_G04 | 3 | 3q24 | 148525900 | 148639469 | 113569 | 13.33 | perfect |
| BAC61_M02 | 3 | 3q26.2 | 170262202 | 170373830 | 111628 | 19.11 | perfect |
| BAC36_N19 | 3 | 3q27.2 | 187248391 | 187394849 | 146458 | 31.4 | perfect |

TABLE 5
A pooled probe set specific to detecting chromosomal abnormality
in copy number of Chromosome 4 (Pooled probe set 4).

| Bac_ID | Chr. No. | Cyto | Bac_start | Bac_end | Bac_size | Repeat % | Megablast |
|---|---|---|---|---|---|---|---|
| BAC60_H08 | 4 | 4p16.1 | 7720688 | 7861517 | 140829 | 29.89 | perfect |
| BAC26_C10 | 4 | 4p15.2 | 23475540 | 23578343 | 102803 | 21.45 | perfect |
| BAC68_O19 | 4 | 4p13 | 41292867 | 41404193 | 111326 | 22.43 | perfect |
| BAC102_G08 | 4 | 4p12 | 48150595 | 48249718 | 99123 | 28.41 | perfect |
| BAC127_B16 | 4 | 4q13.1 | 59583784 | 59686203 | 102419 | 46.85 | perfect |
| BAC176_G14 | 4 | 4q13.3 | 73393978 | 73505886 | 111908 | 33 | perfect |
| BAC41_O05 | 4 | 4q21.1 | 78338989 | 78446698 | 107709 | 32.37 | perfect |
| BAC37_H04 | 4 | 4q22.3 | 97252146 | 97364557 | 112411 | 36.26 | perfect |
| BAC115_C13 | 4 | 4q25 | 110284871 | 110404724 | 119853 | 32.8 | perfect |
| BAC30_N21 | 4 | 4q26 | 120049222 | 120165673 | 116451 | 34.35 | perfect |
| BAC220_D24 | 4 | 4q28.3 | 134266064 | 134345943 | 79879 | 17.21 | perfect |
| BAC106_P17 | 4 | 4q31.23 | 148133315 | 148244415 | 111100 | 24.89 | perfect |
| BAC41_O11 | 4 | 4q32.1 | 157831745 | 157956901 | 125156 | 33.17 | perfect |
| BAC157_P10 | 4 | 4q32.3 | 169969985 | 170078568 | 108583 | 24.78 | perfect |
| BAC27_L15 | 4 | 4q35.1 | 186746250 | 186847111 | 100861 | 17.97 | perfect |

TABLE 6
A pooled probe set specific to detecting chromosomal abnormality
in copy number of Chromosome 5 (Pooled probe set 5).

| Bac_ID | Chr. No. | Cyto | Bac_start | Bac_end | Bac_size | Repeat % | Megablast |
|---|---|---|---|---|---|---|---|
| BAC86_B20 | 5 | 5p15.2 | 14309256 | 14409481 | 100225 | 20.7 | perfect |
| BAC33_N18 | 5 | 5p14.1 | 25999429 | 26158704 | 159275 | 50.82 | perfect |
| BAC55_L24 | 5 | 5p13.2- | 38403985 | 38527847 | 123862 | 32.3 | perfect |
| | | 5p13.1 | | | | | |
| BAC226_H03 | 5 | 5p12 | 44650743 | 44794555 | 143812 | 50.34 | perfect |
| BAC156_E24 | 5 | 5q11.2 | 58505228 | 58611348 | 106120 | 28.98 | perfect |
| BAC237_B02 | 5 | 5q13.2 | 71448934 | 71560365 | 111431 | 20.72 | perfect |
| BAC29_D17 | 5 | 5q14.3 | 87983275 | 88080419 | 97144 | 13.38 | perfect |
| BAC139_M23 | 5 | 5q22.2 | 112566458 | 112663325 | 96867 | 25.1 | perfect |
| BAC21_J16 | 5 | 5q23.2 | 122456733 | 122564806 | 108073 | 18.34 | perfect |
| BAC27_N23 | 5 | 5q31.1 | 134366901 | 134477059 | 110158 | 25.77 | perfect |
| BAC148_D23 | 5 | 5q33.1 | 149559660 | 149666803 | 107143 | 33.2 | perfect |
| BAC186_L21 | 5 | 5q33.3 | 158095591 | 158197200 | 101609 | 21.95 | perfect |
| BAC238_E21 | 5 | 5q34 | 166902727 | 167015224 | 112497 | 26.28 | perfect |
| BAC175_N07 | 5 | 5q35.2 | 173228824 | 173344604 | 115780 | 32.25 | perfect |

TABLE 7
A pooled probe set specific to detecting chromosomal abnormality
in copy number of Chromosome 6 (Pooled probe set 6).

| Bac_ID | Chr. No. | Cyto | Bac_start | Bac_end | Bac_size | Repeat % | Megablast |
|---|---|---|---|---|---|---|---|
| BAC125_G09 | 6 | 6p22.3 | 15531954 | 15630750 | 98796 | 18.2 | perfect |
| BAC182_E20 | 6 | 6p21.31 | 33763536 | 33871714 | 108178 | 23.32 | perfect |
| BAC81_C08 | 6 | 6p21.1 | 44089494 | 44207145 | 117651 | 36.03 | perfect |
| BAC24_P12 | 6 | 6p12.1 | 56485318 | 56604851 | 119533 | 24.39 | perfect |
| BAC76_A23 | 6 | 6q13 | 70921840 | 71025599 | 103759 | 23.1 | perfect |
| BAC26_F16 | 6 | 6q14.1 | 80924435 | 81042966 | 118531 | 38.26 | perfect |
| BAC43_M14 | 6 | 6q15 | 91854172 | 91954978 | 100806 | 26.81 | perfect |
| BAC27_P17 | 6 | 6q21 | 107961222 | 108059168 | 97946 | 16.28 | perfect |
| BAC1_N23 | 6 | 6q22.2 | 118469623 | 118588188 | 118565 | 39.06 | perfect |
| BAC247_D17 | 6 | 6q22.33 | 128420486 | 128521502 | 101016 | 26.06 | perfect |
| BAC101_M04 | 6 | 6q23.3 | 138540130 | 138646539 | 106409 | 33.26 | perfect |
| BAC90_F08 | 6 | 6q24.2 | 145084822 | 145186048 | 101226 | 27.88 | perfect |
| BAC118_M18 | 6 | 6q25.3 | 157302386 | 157406286 | 103900 | 26.82 | perfect |
| BAC179_N12 | 6 | 6q26 | 161982831 | 162089918 | 107087 | 28.06 | perfect |

TABLE 8
A pooled probe set specific to detecting chromosomal abnormality
in copy number of Chromosome 7 (Pooled probe set 7).

| Bac_ID | Chr. No. | Cyto | Bac_start | Bac_end | Bac_size | Repeat % | Megablast |
|---|---|---|---|---|---|---|---|
| BAC231_L03 | 7 | 7p21.3 | 8392407 | 8510938 | 118531 | 29.27 | perfect |
| BAC82_L17 | 7 | 7p21.1 | 17592473 | 17703514 | 111041 | 44.84 | perfect |
| BAC218_N01 | 7 | 7p15.2 | 27134934 | 27246285 | 111351 | 9.83 | perfect |
| BAC5_A09 | 7 | 7p14.1 | 41971065 | 42072309 | 101244 | 18.63 | perfect |
| BAC170_M16 | 7 | 7p11.2 | 55122494 | 55230463 | 107969 | 15.74 | perfect |
| BAC119_K16 | 7 | 7q11.22 | 69481854 | 69594033 | 112179 | 25.95 | perfect |
| BAC248_P06 | 7 | 7q21.11 | 81669117 | 81775391 | 106274 | 37.26 | perfect |
| BAC96_F02 | 7 | 7q21.3 | 96395369 | 96489640 | 94271 | 18.65 | perfect |
| BAC139_J04 | 7 | 7q31.1 | 107817605 | 107913546 | 95941 | 39.38 | perfect |
| BAC76_K13 | 7 | 7q32.3 | 131748178 | 131844288 | 96110 | 19.98 | perfect |
| BAC192_N04 | 7 | 7q33 | 136905463 | 137009239 | 103776 | 28.94 | perfect |
| BAC154_A21 | 7 | 7q34 | 142687940 | 142795907 | 107967 | 30.5 | cutoff |
| BAC120_I09 | 7 | 7q36.3 | 154894609 | 154994317 | 99708 | 23.61 | perfect |

TABLE 9
A pooled probe set specific to detecting chromosomal abnormality
in copy number of Chromosome 8 (Pooled probe set 8).

| Bac_ID | Chr. No. | Cyto | Bac_start | Bac_end | Bac_size | Repeat % | Megablast |
|---|---|---|---|---|---|---|---|
| BAC150_M15 | 8 | 8p23.1 | 10706703 | 10809056 | 102353 | 19.34 | perfect |
| BAC149_J08 | 8 | 8p21.2 | 25832727 | 25937836 | 105109 | 19.1 | perfect |
| BAC63_M21 | 8 | 8p12 | 32590447 | 32691100 | 100653 | 19.7 | perfect |
| BAC147_O15 | 8 | 8p11.21 | 41666791 | 41781564 | 114773 | 32.27 | perfect |
| BAC44_I16 | 8 | 8q11.21 | 49897613 | 49995230 | 97617 | 32.07 | perfect |
| BAC30_N24 | 8 | 8q12.1 | 60026605 | 60149114 | 122509 | 21.26 | perfect |
| BAC43_J01 | 8 | 8q13.2- | 70570126 | 70680171 | 110045 | 28.01 | perfect |
| | | 8q13.3 | | | | | |
| BAC234_M17 | 8 | 8q21.11 | 77830466 | 77927688 | 97222 | 18.15 | perfect |
| BAC68_K11 | 8 | 8q21.3 | 89314328 | 89429821 | 115493 | 36.14 | perfect |
| BAC200_C08 | 8 | 8q22.3 | 103287335 | 103402138 | 114803 | 34.63 | perfect |
| BAC237_M08 | 8 | 8q23.1 | 106578808 | 106677714 | 98906 | 22.33 | perfect |
| BAC61_N10 | 8 | 8q23.3 | 115840828 | 115937681 | 96853 | 55.69 | perfect |
| BAC80_H19 | 8 | 8q24.13 | 125618138 | 125727013 | 108875 | 32.26 | perfect |
| BAC150_P12 | 8 | 8q24.22 | 135673467 | 135809603 | 136136 | 44.66 | perfect |
| BAC66_I02 | 8 | 8q24.3 | 140926132 | 141036056 | 109924 | 31.05 | perfect |

TABLE 10
A pooled probe set specific to detecting chromosomal abnormality
in copy number of Chromosome 9 (Pooled probe set 9).

| Bac_ID | Chr. No. | Cyto | Bac_start | Bac_end | Bac_size | Repeat % | Megablast |
|---|---|---|---|---|---|---|---|
| BAC80_F23 | 9 | 9p24.1 | 8308622 | 8413950 | 105328 | 26.68 | perfect |
| BAC28_L14 | 9 | 9p22.3 | 14200117 | 14314787 | 114670 | 16.8 | perfect |
| BAC137_L16 | 9 | 9p21.3 | 23665603 | 23759045 | 93442 | 15.87 | perfect |
| BAC161_C10 | 9 | 9q21.11 | 70573449 | 70692423 | 118974 | 34.73 | perfect |
| BAC92_D01 | 9 | 9q21.13 | 77918661 | 78033112 | 114451 | 25.64 | perfect |
| BAC163_H11 | 9 | 9q21.33 | 86735179 | 86840533 | 105354 | 28.08 | perfect |
| BAC12_E22 | 9 | 9q22.32 | 96781575 | 96901045 | 119470 | 19.94 | perfect |
| BAC172_D10 | 9 | 9q31.2 | 108625127 | 108739308 | 114181 | 30.85 | perfect |
| BAC149_L08 | 9 | 9q32 | 115391007 | 115517471 | 126464 | 45.78 | perfect |
| BAC188_O18 | 9 | 9q33.2 | 123482469 | 123582132 | 99663 | 24.2 | cutoff |
| BAC126_N07 | 9 | 9q34.13 | 133669938 | 133789283 | 119345 | 38.25 | perfect |

TABLE 11
A pooled probe set specific to detecting chromosomal abnormality
in copy number of Chromosome 10 (Pooled probe set 10).

| Bac_ID | Chr. No. | Cyto | Bac_start | Bac_end | Bac_size | Repeat % | Megablast |
|---|---|---|---|---|---|---|---|
| BAC170_F05 | 10 | 10p15.1 | 6507791 | 6616487 | 108696 | 34.33 | perfect |
| BAC102_J19 | 10 | 10p14 | 11202864 | 11309078 | 106214 | 19.15 | perfect |
| BAC40_P04 | 10 | 10p13 | 13767514 | 13888447 | 120933 | 35.21 | perfect |
| BAC141_E23 | 10 | 10p12.1 | 24780160 | 24883204 | 103044 | 31.14 | perfect |
| BAC246_I22 | 10 | 10p11.22- | 34430488 | 34539131 | 108643 | 24.22 | perfect |
| | | 10p11.21 | | | | | |
| BAC14_K16 | 10 | 10q11.21 | 44702716 | 44811838 | 109122 | 32.14 | perfect |
| BAC52_B14 | 10 | 10q22.2 | 75183312 | 75288876 | 105564 | 29.18 | perfect |
| BAC158_C10 | 10 | 10q23.31 | 89877530 | 89994800 | 117270 | 34.92 | perfect |
| BAC155_O18 | 10 | 10q24.32 | 103344207 | 103439821 | 95614 | 24.62 | perfect |
| BAC144_E19 | 10 | 10q25.2 | 114771881 | 114884798 | 112917 | 22.92 | perfect |
| BAC218_E11 | 10 | 10q26.13 | 123194345 | 123298554 | 104209 | 28.5 | perfect |
| BAC48_I12 | 10 | 10q26.13 | 126688077 | 126783871 | 95794 | 18.83 | perfect |
| BAC182_N07 | 10 | 10q26.3 | 130655243 | 130754961 | 99718 | 19.47 | perfect |

TABLE 12
A pooled probe set specific to detecting chromosomal abnormality
in copy number of Chromosome 11 (Pooled probe set 11).

| Bac_ID | Chr. No. | Cyto | Bac_start | Bac_end | Bac_size | Repeat % | Megablast |
|---|---|---|---|---|---|---|---|
| BAC68_K10 | 11 | 11p15.2 | 12761489 | 12858699 | 97210 | 21.81 | perfect |
| BAC90_E18 | 11 | 11p14.3 | 23422886 | 23527116 | 104230 | 52.57 | perfect |
| BAC24_K17 | 11 | 11p13 | 34043974 | 34159762 | 115788 | 32.53 | cutoff |
| BAC58_O19 | 11 | 11p11.2 | 45844027 | 45945118 | 101091 | 28.31 | cutoff |
| BAC36_K05 | 11 | 11q12.2 | 61222569 | 61318879 | 96310 | 23.4 | perfect |
| BAC150_P20 | 11 | 11q13.3 | 70323804 | 70440259 | 116455 | 27.67 | perfect |
| BAC154_H22 | 11 | 11q14.1 | 80897410 | 80995179 | 97769 | 41.22 | perfect |
| BAC26_C09 | 11 | 11q21 | 95341253 | 95452490 | 111237 | 33.28 | perfect |
| BAC119_O13 | 11 | 11q22.3 | 105421723 | 105552485 | 130762 | 51.39 | perfect |
| BAC195_O14 | 11 | 11q23.2 | 114533244 | 114632257 | 99013 | 9.77 | perfect |
| BAC73_E17 | 11 | 11q23.3 | 120257418 | 120365515 | 108097 | 29.74 | perfect |
| BAC142_K09 | 11 | 11q24.3 | 128061292 | 128178954 | 117662 | 22.6 | perfect |
| BAC65_D19 | 11 | 11q25 | 132481572 | 132589407 | 107835 | 24.68 | perfect |

TABLE 13
A pooled probe set specific to detecting chromosomal abnormality
in copy number of Chromosome 12 (Pooled probe set 12).

| Bac_ID | Chr. No. | Cyto | Bac_start | Bac_end | Bac_size | Repeat % | Megablast |
|---|---|---|---|---|---|---|---|
| BAC60_I23 | 12 | 12p13.2 | 11701743 | 11809262 | 107519 | 24.36 | perfect |
| BAC121_P21 | 12 | 12p11.23 | 26689788 | 26798168 | 108380 | 34.03 | cutoff |
| BAC199_G02 | 12 | 12q12 | 39582488 | 39679490 | 97002 | 25.88 | perfect |
| BAC65_G10 | 12 | 12q13.13 | 51215952 | 51320650 | 104698 | 29.86 | perfect |
| BAC41_I18 | 12 | 12q13.2 | 53220091 | 53326596 | 106505 | 32.93 | perfect |
| BAC10_M07 | 12 | 12q14.3 | 64499036 | 64596568 | 97532 | 24.53 | perfect |
| BAC39_O14 | 12 | 12q21.1 | 73748137 | 73850966 | 102829 | 26.13 | perfect |
| BAC144_K11 | 12 | 12q21.32 | 86754102 | 86851280 | 97178 | 45.83 | perfect |
| BAC178_M15 | 12 | 12q23.2 | 101295480 | 101408773 | 113293 | 29.29 | perfect |
| BAC134_M17 | 12 | 12q24.21 | 114892621 | 114996460 | 103839 | 27.37 | perfect |
| BAC65_I21 | 12 | 12q24.31 | 122960995 | 123070617 | 109622 | 27.37 | perfect |
| BAC27_E08 | 12 | 12q24.33 | 130071553 | 130182033 | 110480 | 33.15 | cutoff |

TABLE 14
A pooled probe set specific to detecting chromosomal abnormality
in copy number of Chromosome 13 (Pooled probe set 13).

| Bac_ID | Chr. No. | Cyto | Bac_start | Bac_end | Bac_size | Repeat % | Megablast |
|---|---|---|---|---|---|---|---|
| BAC28_H21 | 13 | 13q12.13 | 25143222 | 25245331 | 102109 | 27.22 | perfect |
| BAC163_F01 | 13 | 13q12.3 | 30534492 | 30645395 | 110903 | 29.45 | perfect |
| BAC78_C21 | 13 | 13q14.3 | 51185202 | 51293792 | 108590 | 31.63 | perfect |
| BAC135_O03 | 13 | 13q21.31 | 61708361 | 61820641 | 112280 | 48.99 | perfect |
| BAC237_P24 | 13 | 13q21.33 | 71970035 | 72071453 | 101418 | 28.19 | perfect |
| BAC84_N09 | 13 | 13q31.1 | 85224563 | 85327840 | 103277 | 31.28 | perfect |
| BAC8_C18 | 13 | 13q32.1 | 96626342 | 96733503 | 107161 | 30.97 | perfect |
| BAC133_G23 | 13 | 13q33.3 | 105875452 | 105978338 | 102886 | 21.77 | perfect |
| BAC116_B15 | 13 | 13q34 | 109618954 | 109723753 | 104799 | 17.82 | perfect |

TABLE 15
A pooled probe set specific to detecting chromosomal abnormality
in copy number of Chromosome 14 (Pooled probe set 14).

| Bac_ID | Chr. No. | Cyto | Bac_start | Bac_end | Bac_size | Repeat % | Megablast |
|---|---|---|---|---|---|---|---|
| BAC236_F24 | 14 | 14q11.2 | 22882169 | 22975980 | 93811 | 17.8 | perfect |
| BAC22_E01 | 14 | 14q13.1 | 33051075 | 33164524 | 113449 | 19.32 | perfect |
| BAC37_K09 | 14 | 14q21.3 | 46529853 | 46639288 | 109435 | 27.08 | perfect |
| BAC79_J20 | 14 | 14q23.1 | 56316365 | 56426133 | 109768 | 29.93 | perfect |
| BAC50_I09 | 14 | 14q23.1 | 58784060 | 58905688 | 121628 | 24.33 | perfect |
| BAC15_E12 | 14 | 14q24.2 | 69499442 | 69615359 | 115917 | 28.53 | perfect |
| BAC63_O11 | 14 | 14q24.3 | 76716134 | 76840351 | 124217 | 32.66 | perfect |
| BAC11_N10 | 14 | 14q31.3 | 85117915 | 85219573 | 101658 | 29.18 | perfect |
| BAC39_P02 | 14 | 14q32.13 | 93445004 | 93557400 | 112396 | 35.57 | perfect |
| BAC101_O15 | 14 | 14q32.31 | 100503542 | 100635568 | 132026 | 27.01 | perfect |

TABLE 16
A pooled probe set specific to detecting chromosomal abnormality
in copy number of Chromosome 15 (Pooled probe set 15).

| Bac_ID | Chr. No. | Cyto | Bac_start | Bac_end | Bac_size | Repeat % | Megablast |
|---|---|---|---|---|---|---|---|
| BAC66_K21 | 15 | 15q14 | 34891569 | 34992991 | 101422 | 25.7 | perfect |
| BAC162_K11 | 15 | 15q15.1 | 39911516 | 40017191 | 105675 | 21.32 | cutoff |
| BAC178_K16 | 15 | 15q21.1 | 46636419 | 46734018 | 97599 | 25.1 | perfect |
| BAC21_K13 | 15 | 15q21.3 | 55514115 | 55623430 | 109315 | 31.83 | perfect |
| BAC167_M02 | 15 | 15q22.2 | 60804474 | 60910289 | 105815 | 24.56 | perfect |
| BAC88_F18 | 15 | 15q22.33 | 65152593 | 65266241 | 113648 | 30.99 | perfect |
| BAC168_F12 | 15 | 15q24.1 | 72269733 | 72378984 | 109251 | 30.64 | perfect |
| BAC10_E08 | 15 | 15q25.1 | 78883923 | 78994040 | 110117 | 30.34 | perfect |
| BAC177_H09 | 15 | 15q25.3 | 86262818 | 86362227 | 99409 | 24.84 | perfect |
| BAC41_K03 | 15 | 15q26.2 | 94625429 | 94735125 | 109696 | 19.8 | perfect |

TABLE 17
A pooled probe set specific to detecting chromosomal abnormality
in copy number of Chromosome 16 (Pooled probe set 16).

| Bac_ID | Chr. No. | Cyto | Bac_start | Bac_end | Bac_size | Repeat % | Megablast |
|---|---|---|---|---|---|---|---|
| BAC38_I04 | 16 | 16p13.2 | 7236659 | 7345065 | 108406 | 32.18 | perfect |
| BAC96_J19 | 16 | 16p12.3 | 17301008 | 17430114 | 129106 | 46.81 | perfect |
| BAC120_K24 | 16 | 16p12.1 | 22880407 | 23000700 | 120293 | 47.38 | |
| BAC177_P23 | 16 | 16p11.2 | 27677745 | 27824753 | 147008 | 50.93 | perfect |
| BAC247_B03 | 16 | 16q12.1 | 46582236 | 46708479 | 126243 | 41.47 | perfect |
| BAC117_H14 | 16 | 16q13 | 54857795 | 54968957 | 111162 | 30.04 | perfect |
| BAC96_G02 | 16 | 16q21 | 63766221 | 63897034 | 130813 | 45.04 | perfect |
| BAC24_D17 | 16 | 16q22.3 | 71392858 | 71500676 | 107818 | 19.52 | perfect |
| BAC223_D19 | 16 | 16q23.1- | 78124140 | 78223124 | 98984 | 22.27 | perfect |
| | | 16q23.2 | | | | | |

TABLE 18
A pooled probe set specific to detecting chromosomal abnormality
in copy number of Chromosome 17 (Pooled probe set 17).

| Bac_ID | Chr. No. | Cyto | Bac_start | Bac_end | Bac_size | Repeat % | Megablast |
|---|---|---|---|---|---|---|---|
| BAC200_M05 | 17 | 17p13.1 | 9003380 | 9112032 | 108652 | 33.57 | perfect |
| BAC50_A03 | 17 | 17p12 | 13241293 | 13370269 | 128976 | 38.5 | cutoff |
| BAC149_H11 | 17 | 17q11.2 | 23828734 | 23932422 | 103688 | 30.88 | cutoff |
| BAC29_G13 | 17 | 17q12 | 34946421 | 35061427 | 115006 | 33.07 | perfect |
| BAC238_E06 | 17 | 17q21.33 | 45499528 | 45605085 | 105557 | 31.58 | perfect |
| BAC150_O15 | 17 | 17q22 | 53010880 | 53111488 | 100608 | 24.52 | perfect |
| BAC70_P11 | 17 | 17q24.2 | 61859026 | 61963885 | 104859 | 32.08 | perfect |
| BAC70_N11 | 17 | 17q24.3 | 66884538 | 66990764 | 106226 | 27.85 | perfect |
| BAC116_E10 | 17 | 17q25.1 | 70287026 | 70396381 | 109355 | 22.68 | perfect |
| BAC48_K14 | 17 | 17q25.3 | 74796956 | 74899041 | 102085 | 25.69 | perfect |

TABLE 19
A pooled probe set specific to detecting chromosomal abnormality
in copy number of Chromosome 18 (Pooled probe set 18).

| Bac_ID | Chr. No. | Cyto | Bac_start | Bac_end | Bac_size | Repeat % | Megablast |
|---|---|---|---|---|---|---|---|
| BAC57_H08 | 18 | 18p11.31 | 6965630 | 7083991 | 118361 | 34.11 | perfect |
| BAC141_I04 | 18 | 18p11.21 | 13204635 | 13303487 | 98852 | 27.8 | perfect |
| BAC252_H16 | 18 | 18q12.1 | 23925558 | 24030666 | 105108 | 27.58 | perfect |
| BAC232_E19 | 18 | 18q12.2 | 33328623 | 33432257 | 103634 | 20 | perfect |
| BAC149_I18 | 18 | 18q12.3 | 40492533 | 40595058 | 102525 | 22.9 | perfect |
| BAC186_P19 | 18 | 18q21.1 | 45732647 | 45836159 | 103512 | 26.99 | perfect |
| BAC151_L02 | 18 | 18q21.31 | 52732610 | 52834222 | 101612 | 23.29 | perfect |
| BAC230_C11 | 18 | 18q21.33 | 59076118 | 59172880 | 96762 | 34.04 | perfect |
| BAC43_A24 | 18 | 18q22.3 | 66979772 | 67088762 | 108990 | 33.25 | perfect |
| BAC184_J04 | 18 | 18q23 | 72199921 | 72294263 | 94342 | 15.35 | perfect |

TABLE 20
A pooled probe set specific to detecting chromosomal abnormality
in copy number of Chromosome 19 (Pooled probe set 19).

| Bac_ID | Chr. No. | Cyto | Bac_start | Bac_end | Bac_size | Repeat % | Megablast |
|---|---|---|---|---|---|---|---|
| BAC178_L22 | 19 | 19p13.2 | 7576484 | 7669091 | 92607 | 37.74 | perfect |
| BAC160_C11 | 19 | 19p13.13 | 12904676 | 13008809 | 104133 | 38.79 | perfect |
| BAC131_N13 | 19 | 19p13.11 | 19434885 | 19546124 | 111239 | 31.54 | perfect |
| BAC54_N22 | 19 | 19q12 | 33062070 | 33154105 | 92035 | 40.36 | perfect |
| BAC233_K14 | 19 | 19q12 | 36444841 | 36543930 | 99089 | 14.4 | perfect |
| BAC162_K04 | 19 | 19q13.2 | 44526488 | 44654105 | 127617 | 42.27 | perfect |
| BAC76_E22 | 19 | 19q13.32 | 52164544 | 52276406 | 111862 | 48.89 | perfect |
| BAC211_B15 | 19 | 19q13.33 | 54533050 | 54646094 | 113044 | 43.14 | perfect |
| BAC101_H02 | 19 | 19q13.42 | 60824176 | 60920115 | 95939 | 35.56 | cutoff |
| BAC193_C07 | 19 | 19q13.42 | 61263496 | 61377134 | 113638 | 49.1 | perfect |

TABLE 21
A pooled probe set specific to detecting chromosomal abnormality
in copy number of Chromosome 20 (Pooled probe set 20).

| Bac_ID | Chr. No. | Cyto | Bac_start | Bac_end | Bac_size | Repeat % | Megablast |
|---|---|---|---|---|---|---|---|
| BAC247_K09 | 20 | 20p12.2 | 10566085 | 10662978 | 96893 | 25.39 | perfect |
| BAC26_J24 | 20 | 20p12.1 | 16274790 | 16388873 | 114083 | 29.8 | perfect |
| BAC75_H16 | 20 | 20p11.23 | 20305001 | 20413595 | 108594 | 26.25 | perfect |
| BAC37_M13 | 20 | 20p11.21 | 24534588 | 24661098 | 126510 | 40.05 | perfect |
| BAC19_G17 | 20 | 20q11.22 | 33307625 | 33429006 | 121381 | 38.42 | perfect |
| BAC82_B07 | 20 | 20q12 | 38733854 | 38837009 | 103155 | 30.96 | perfect |
| BAC96_H08 | 20 | 20q13.13 | 48537102 | 48674679 | 137577 | 38.72 | perfect |
| BAC166_J02 | 20 | 20q13.2 | 51088180 | 51201285 | 113105 | 36.98 | perfect |
| BAC41_E11 | 20 | 20q13.32 | 56785564 | 56882008 | 96444 | 19.43 | perfect |
| BAC146_N07 | 20 | 20q13.33 | 59644343 | 59742642 | 98299 | 24.11 | perfect |

TABLE 22
A pooled probe set specific to detecting chromosomal abnormality
in copy number of Chromosome 21 (Pooled probe set 21).

| Bac_ID | Chr. No. | Cyto | Bac_start | Bac_end | Bac_size | Repeat % | Megablast |
|---|---|---|---|---|---|---|---|
| BAC102_F10 | 21 | 21q11.2 | 14571029 | 14713371 | 142342 | 42.45 | perfect |
| BAC240_M07 | 21 | 21q21.1 | 18530589 | 18634646 | 104057 | 26.14 | perfect |
| BAC200_O02 | 21 | 21q21.1 | 21711102 | 21810394 | 99292 | 32.67 | perfect |
| BAC97_O19 | 21 | 21q21.2 | 25370877 | 25503818 | 132941 | 39.84 | perfect |
| BAC119_K07 | 21 | 21q21.3 | 27746038 | 27845927 | 99889 | 37.68 | perfect |
| BAC200_A23 | 21 | 21q21.3 | 30135569 | 30259474 | 123905 | 34.86 | perfect |
| BAC221_D22 | 21 | 21q22.11 | 32955508 | 33054881 | 99373 | 36.91 | perfect |
| BAC100_D11 | 21 | 21q22.12 | 35144569 | 35254293 | 109724 | 22.05 | perfect |
| BAC33_D15 | 21 | 21q22.13 | 38404833 | 38548664 | 143831 | 46.69 | perfect |
| BAC126_M10 | 21 | 21q22.3 | 42518138 | 42622787 | 104649 | 25.5 | perfect |

TABLE 23
A pooled probe set specific to detecting chromosomal abnormality
in copy number of Chromosome 22 (Pooled probe set 22).

| Bac_ID | Chr. No. | Cyto | Bac_start | Bac_end | Bac_size | Repeat % | Megablast |
|---|---|---|---|---|---|---|---|
| BAC169_G07 | 22 | 22q11.22- | 21785657 | 21898492 | 112835 | 36.87 | perfect |
| | | 22q11.23 | | | | | |
| BAC153_I19 | 22 | 22q12.1 | 24588271 | 24689820 | 101549 | 42.87 | perfect |
| BAC100_P10 | 22 | 22q12.1 | 26700102 | 26828418 | 128316 | 35.55 | perfect |
| BAC37_J03 | 22 | 22q12.2 | 28383741 | 28496470 | 112729 | 34.07 | perfect |
| BAC187_K08 | 22 | 22q12.3 | 31516566 | 31610860 | 94294 | 31.84 | perfect |
| BAC131_H09 | 22 | 22q12.3 | 35000557 | 35127809 | 127252 | 35.12 | perfect |
| BAC106_C07 | 22 | 22q13.1 | 36052892 | 36157674 | 104782 | 30.88 | perfect |
| BAC66_M06 | 22 | 22q13.1 | 39087833 | 39203708 | 115875 | 44.27 | perfect |
| BAC51_M21 | 22 | 22q13.2 | 41943878 | 42052803 | 108925 | 26.49 | perfect |
| BAC153_O04 | 22 | 22q13.31 | 45111661 | 45224294 | 112633 | 32.1 | perfect |

TABLE 24
A pooled probe set specific to detecting chromosomal abnormality
in copy number of Chromosome X (Pooled probe set 23).

| Bac_ID | Chr. No. | Cyto | Bac_start | Bac_end | Bac_size | Repeat % | Megablast |
|---|---|---|---|---|---|---|---|
| BAC70_N16 | X | Xp22.2 | 12242131 | 12358309 | 116178 | 31.61 | perfect |
| BAC22_H14 | X | Xp22.12 | 19530397 | 19656785 | 126388 | 32.17 | perfect |
| BAC65_L14 | X | Xp21.2 | 29622036 | 29749045 | 127009 | 37.56 | perfect |
| BAC151_A03 | X | Xp11.4 | 39814492 | 39933265 | 118773 | 25.85 | perfect |
| BAC49_G05 | X | Xp11.23 | 48447858 | 48563861 | 116003 | 46.6 | cutoff |
| BAC130_K20 | X | Xq11.1 | 62871569 | 62971143 | 99574 | 58.25 | perfect |
| BAC103_N15 | X | Xq13.1 | 71429226 | 71542407 | 113181 | 54.37 | perfect |
| BAC136_M01 | X | Xq21.1 | 79808105 | 79900354 | 92249 | 40.85 | perfect |
| BAC6_B17 | X | Xq21.33 | 96022346 | 96133479 | 111133 | 36.07 | perfect |
| BAC141_P03 | X | Xq22.2- | 103499406 | 103603159 | 103753 | 54.93 | perfect |
| | | Xq22.3 | | | | | |
| BAC246_K02 | X | Xq22.3 | 106558477 | 106677904 | 119427 | 35.9 | perfect |
| BAC91_J24 | X | Xq22.3 | 110215405 | 110332259 | 116854 | 29.71 | perfect |
| BAC97_C11 | X | Xq25 | 122558528 | 122669264 | 110736 | 42.3 | perfect |
| BAC63_G23 | X | Xq25 | 128963506 | 129081155 | 117649 | 35.44 | perfect |
| BAC73_B07 | X | Xq26.2 | 131631150 | 131750852 | 119702 | 34.86 | perfect |
| BAC162_B10 | X | Xq27.2 | 141489490 | 141600695 | 111205 | 52 | perfect |
| BAC119_C15 | X | Xq28 | 149354893 | 149476738 | 121845 | 37.97 | perfect |

TABLE 25
A pooled probe set specific to detecting chromosomal abnormality
in copy number of Chromosome Y (Pooled probe set 24).

| Bac_ID | Chr. No. | Cyto | Bac_start | Bac_end | Bac_size | Repeat % | Megablast |
|---|---|---|---|---|---|---|---|
| BAC24_K23 | Y | Yp11.2 | 8029316 | 8132309 | 102993 | 61.88 | cutoff |
| BAC205_L13 | Y | Yp11.2 | 8607008 | 8706082 | 99074 | 19.28 | perfect |
| BAC127_H21 | Y | Yq11.21 | 13495385 | 13609582 | 114197 | 62.45 | perfect |
| BAC192_M14 | Y | Yq11.21 | 13970303 | 14064396 | 94093 | 63.95 | cutoff |
| BAC101_I21 | Y | Yq11.21 | 14086977 | 14174195 | 87218 | 79.82 | perfect |
| BAC140_H17 | Y | Yq11.221 | 16177603 | 16271634 | 94031 | 54.31 | cutoff |
| BAC65_J16 | Y | Yq11.221 | 17261230 | 17382688 | 121458 | 60.27 | perfect |
| BAC180_K16 | Y | Yq11.221 | 17415806 | 17520345 | 104539 | 63.58 | perfect |
| BAC102_F03 | Y | Yq11.221 | 17655546 | 17754959 | 99413 | 47.54 | perfect |
| BAC31_L01 | Y | Yq11.222 | 19643980 | 19738325 | 94345 | 72.53 | perfect |
| BAC240_H05 | Y | Yq11.222 | 20119719 | 20208748 | 89029 | 60.43 | perfect |

TABLE 26
A pooled probe set specific to Wolf-Hirschhorn syndrome (WHS) (Pooled probe set 25).

| Bac_ID | Chr. No. | Cyto | Bac_start | Bac_end | Bac_size | Repeat % | Disease |
|---|---|---|---|---|---|---|---|
| BAC50_H08 | 4 | 4p16.3 | 1784731 | 1916874 | 132143 | 47 | WHS |
| BAC67_I12 | 4 | 4p16.3 | 1873050 | 1980658 | 107608 | 41 | WHS |
| BAC100_E03 | 4 | 4p16.3 | 1878656 | 1996081 | 117425 | 46 | WHS |
| BAC1_F06 | 4 | 4p16.3 | 1890838 | 1985011 | 94173 | 40 | WHS |
| BAC135_O20 | 4 | 4p16.3 | 1932272 | 2020557 | 88285 | 57 | WHS |
| BAC153_J14 | 4 | 4p16.3 | 2049082 | 2129247 | 80165 | 52 | WHS |

TABLE 27
A pooled probe set specific to Cri-Du-Chat syndrome (CRI-DU-CHAT) (Pooled probe set 26).

| Bac_ID | Chr. No. | Cyto | Bac_start | Bac_end | Bac_size | Repeat % | Disease |
|---|---|---|---|---|---|---|---|
| BAC143_N22 | 5 | 5p15.2 | 9511494 | 9591939 | 80445 | 25 | CRI-DU-CHAT |
| BAC206_I13 | 5 | 5p15.2 | 9591934 | 9697824 | 105890 | 46 | CRI-DU-CHAT |
| BAC252_N08 | 5 | 5p15.2 | 9710410 | 9842377 | 131967 | 49 | CRI-DU-CHAT |
| BAC64_P22 | 5 | 5p15.2 | 9737985 | 9835999 | 98014 | 46 | CRI-DU-CHAT |
| BAC208_N21 | 5 | 5p15.2 | 9741001 | 9872689 | 131688 | 46 | CRI-DU-CHAT |
| BAC200_E05 | 5 | 5p15.2 | 9761722 | 9855167 | 93445 | 48 | CRI-DU-CHAT |
| BAC240_K06 | 5 | 5p15.2 | 9775708 | 9856013 | 80305 | 48 | CRI-DU-CHAT |

TABLE 28
A pooled probe set specific to William syndrome (WBS) (Pooled probe set 27).

| Bac_ID | Chr. No. | Cyto | Bac_start | Bac_end | Bac_size | Repeat % | Disease |
|---|---|---|---|---|---|---|---|
| BAC69_O08 | 7 | 7q11.23 | 72999634 | 73099848 | 100214 | 50 | WBS |
| BAC66_N22 | 7 | 7q11.23 | 73117049 | 73203244 | 86195 | 69 | WBS |
| BAC180_N24 | 7 | 7q11.23 | 73146401 | 73238493 | 92092 | 71 | WBS |
| BAC67_C05 | 7 | 7q11.23 | 73215245 | 73346881 | 131636 | 54 | WBS |
| BAC183_A12 | 7 | 7q11.23 | 73343227 | 73447186 | 103959 | 63 | WBS |
| BAC123_D05 | 7 | 7q11.23 | 73347015 | 73426987 | 79972 | 64 | WBS |

TABLE 29
A pooled probe set specific to Prader-willi syndrome (PWS)
and Angelman syndrome (AS) (Pooled probe set 28).

| Bac_ID | Chr. No. | Cyto | Bac_start | Bac_end | Bac_size | Repeat % | Disease |
|---|---|---|---|---|---|---|---|
| BAC188_N24 | 15 | 15q11.2 | 21607011 | 21719880 | 112869 | 59 | PWS |
| BAC223_H02 | 15 | 15q11.2 | 22694476 | 22779891 | 85415 | 57 | PWS |
| BAC217_F02 | 15 | 15q11.2 | 22767885 | 22856153 | 88268 | 33 | PWS |
| BAC71_A18 | 15 | 15q11.2 | 23101822 | 23188315 | 86493 | 49 | PWS |
| BAC5_L18 | 15 | 15q11.2- | 23211569 | 23311228 | 99659 | 50 | PWS |
| | | 15q12 | | | | | |
| BAC248_C13 | 15 | 15q12 | 24281096 | 24383877 | 102781 | 50 | PWS |
| BAC78_F07 | 15 | 15q12 | 24369659 | 24485628 | 115969 | 45 | PWS |
| BAC180_J22 | 15 | 15q12 | 24398126 | 24505662 | 107536 | 47 | PWS |
| BAC21_O06 | 15 | 15q12 | 24429411 | 24553835 | 124424 | 42 | PWS |
| BAC105_L07 | 15 | 15q12 | 24456681 | 24577646 | 120965 | 38 | PWS |

TABLE 30
A pooled probe set specific to Miller-Dieker Lissencephaly
syndrome (MDLS) (Pooled probe set 29).

| Bac_ID | Chr. No. | Cyto | Bac_start | Bac_end | Bac_size | Repeat % | Disease |
|---|---|---|---|---|---|---|---|
| BAC95_J10 | 17 | 17p13.3 | 26911 | 101177 | 74266 | 35 | MDLS |
| BAC75_C17 | 17 | 17p13.3 | 138128 | 251064 | 112936 | 40 | MDLS |
| BAC110_O13 | 17 | 17p13.3 | 157851 | 293897 | 136046 | 49 | MDLS |
| BAC63_J08 | 17 | 17p13.3 | 2340899 | 2445465 | 104566 | 69 | MDLS |
| BAC190_F10 | 17 | 17p13.3 | 2388499 | 2488318 | 99819 | 66 | MDLS |
| BAC186_M15 | 17 | 17p13.3 | 2460766 | 2633700 | 172934 | 53 | MDLS |
| BAC183_M06 | 17 | 17p13.3 | 2489245 | 2574271 | 85026 | 42 | MDLS |
| BAC135_N07 | 17 | 17p13.3 | 2510283 | 2624227 | 113944 | 47 | MDLS |
| BAC148_F06 | 17 | 17p13.3 | 2517812 | 2603600 | 85788 | 41 | MDLS |
| BAC31_H03 | 17 | 17p13.3 | 2517823 | 2603600 | 85777 | 41 | MDLS |

TABLE 31
A pooled probe set specific to Smith-Magenis syndrome (SMS) (Pooled probe set 30).

| Bac_ID | Chr. No. | Cyto | Bac_start | Bac_end | Bac_size | Repeat % | Disease |
|---|---|---|---|---|---|---|---|
| BAC249_G12 | 17 | 17p11.2 | 17516703 | 17630050 | 113347 | 32 | SMS |
| BAC41_D18 | 17 | 17p11.2 | 17630085 | 17765348 | 135263 | 28 | SMS |
| BAC186_E14 | 17 | 17p11.2 | 18072869 | 18192554 | 119685 | 36 | SMS |

TABLE 32
A pooled probe set specific to Digeorge syndrome (DGS) (Pooled probe set 31).

| Bac_ID | Chr. No. | Cyto | Bac_start | Bac_end | Bac_size | Repeat % | Disease |
|---|---|---|---|---|---|---|---|
| BAC124_E21 | 22 | 22q11.21 | 17410620 | 17526065 | 115445 | 48 | DGS |
| BAC196_A22 | 22 | 22q11.21 | 17446169 | 17542727 | 96558 | 48 | DGS |
| BAC69_P21 | 22 | 22q11.21 | 17647712 | 17740090 | 92378 | 69 | DGS |
| BAC141_K20 | 22 | 22q11.21 | 17690557 | 17773366 | 82809 | 53 | DGS |
| BAC169_K21 | 22 | 22q11.21 | 17690557 | 17773305 | 82748 | 53 | DGS |
| BAC145_P12 | 22 | 22q11.21 | 17726605 | 17889246 | 162641 | 43 | DGS |
| BAC224_F10 | 22 | 22q11.21 | 17759912 | 17870524 | 110612 | 43 | DGS |

TABLE 33
A pooled probe set specific to Steroid Sulfatase deficiency (STS) (Pooled probe set 32).

| Bac_ID | Chr. No. | Cyto | Bac_start | Bac_end | Bac_size | Repeat % | Disease |
|---|---|---|---|---|---|---|---|
| BAC221_A12 | X | Xp22.31 | 7088532 | 7186942 | 98410 | 46 | STS |
| BAC191_E24 | X | Xp22.31 | 7397582 | 7504424 | 106842 | 44 | STS |
| BAC231_F19 | X | Xp22.31 | 7547752 | 7636445 | 88693 | 42 | STS |

The microarray according to the present invention may be an array comparative genome hybridization (aCGH)-based in vitro diagnostic microarray. CGH has been commonly used to detect an amplification or micro-deletion of a specific chromosomal region. Recently, it has been combined with DNA microarray technology (i.e., aCGH), making it possible to analyze a large scale of DNA at one time. Further, the aCGH technology also makes it possible to simultaneously detect change in the gene expression amount and aberration in DNA copy number.

In another aspect, the present invention relates to a method of preparing the microarray chip comprising the step of immobilizing one or more selected from the group consisting of pooled probe sets 1 to 32 in spots on a substrate, wherein all probes belonging to each pooled probe set are immobilized together in a spot, and the microarray chip may comprise at least one spot for each pooled probe set. The number of the spots for each pooled probe set may be properly adjusted by considering the intended use and purpose, the total number of the used pooled primer sets, the total area of the chip, and the like.

The microarray may be prepared by the general method in the art. For example, the probe is immobilized on a substrate for microarray through physical or chemical binding. The probe may be immobilized according to the general immobilization method used in the preparation of the microarray chip, for examples photolithography, piezoelectric printing, micro-pipetting method or spotting method.

As described above, the substrate may be made one or more materials selected from the group consisting of silicone wafer, glass, polycarbonate, nitrocellulose or nylon membrane, polymer films such as polystyrene or polyurethane, and porous materials.

In yet another aspect embodiment, the present invention relates to a method of detecting chromosomal abnormalities using the microarray chip comprising one or more selected from the group consisting of pooled probe sets 1 to 32. The chromosomal abnormalities may include copy number variation(s) and/or micro-deletion(s) of specific chromosomal region(s) associated with various genetic alterations including pre-natal and/or post-natal disorders. Therefore, the method of the present invention may be used prenatally as well as postnatally. For detection by the present invention, micro well plate, for example 96-well plate may be used so that labeling, hybridization, and washing process can be performed with the automatic machines (for examples, Biomek, and Genetix robot).

More specifically, the method of detecting chromosomal abnormalities may comprise the steps of:

providing a microarray chip by immobilizing one or more selected from the group consisting of pooled probe sets 1 to 32 in spots on a substrate as described above;

labeling a test sample DNA and a reference DNA with different labels from each other;

fragmentizing the labeled DNAs, and applying the obtained test sample DNA fragments and the obtained reference DNA fragments onto the spots on the microarray chip, respectively, to hybridize the DNA fragments with the probes in the spot;

measuring a signal intensity from each pooled probe set hybridized with the test sample DNA or the reference DNA; and

comparing the signal intensity from the test sample DNA over that from the reference DNA.

The signal intensity indicates the hybridization ratio of the test sample or reference DNA fragment. The result of the comparison provides the bases of determination of chromosomal abnormality, as follows:

No chromosomal abnormality, if the hybridization ratio of the target genomic DNA is the same as that of the reference DNA is decided to produce no chromosome abnormality,

Chromosome amplification, if the hybridization ratio of the target genomic DNA is higher than that of the reference DNA.

Chromosome deletion, if the hybridization ratio of the target genomic DNA is lower than that of the reference DNA.

The labels used in the labeling step for the test sample DNA and the reference DNA may be fluorescent dyes with different colors from each other and independently selected from the group consisting of radioactive isotope, fluorescent material, chemical luminescent, and enzyme. For examples, the labels are selected from the group consisting of Cy3, Cy5, Alexa Fluor 350, Alexa Fluor 430, Alexa Fluor 488, Alexa Fluor 532, Alexa Fluor 546, Alexa Fluor 594, Alexa Fluor 658, Cyanine-3, Cyanine-5, fluorescein, bodipy, Texas red, FITC (Fluorescein Isothiocyanate), rhodamine, d-NTP (including d-UTP), reactive dye having amino-allyl modified dNTPs, horseradish peroxidase, biotin and etc. In the concrete embodiment of the present invention, the test sample DNA may be labeled with Cy3 (green fluorescence), and the reference DNA with Cy5 (red fluorescence). Then, the two fluorescently hybridized intensities from each probe are captured by a proper image analyzer, such as, a fluorescent image scanner. The observed two fluorescently hybridized intensities may be converted into values of copy numbers by a proper analysis software, such as MacView™ (Macrogen). The ratio of the value from the test sample over that from the reference shows whether the rest sample has any changes in copy number compared to the reference. The copy number may be a copy number of a specific chromosome, or a specific chromosomal region, which can be detected by the used probe.

Specifically, after co-hybridization of labeled test sample and reference DNA fragment performed, the hybridization ratios of the probes and the test sample or reference DNA fragment may be represented as T/R which is the value of sample (T)'s fluorescence intensity divided by reference (R)'s fluorescence intensity. Theoretically T/R may equal 1, if the test sample and the reference have the same number of chromosome copies (n=2, disomic state). Therefore, T/R>1 means that the sample's fluorescence intensity is higher than the reference, indicating the sample's chromosome or chromosomal region corresponding to the used probe is amplified (copy number gain). In contrast, T/R<1 means that the sample's fluorescence intensity is lower than the reference, indicating the sample's chromosome or chromosomal region corresponding to the used probe is deleted (copy number loss).

Even though chromosomes have the same copy numbers (i.e., two copy of each chromosome for test and reference samples), each clone's T/R value is slightly different due to the inherent genomic polymorphism compounded by the experimental noise. Therefore, to ascertain the meaningful and measurable copy number variations as output, an empirically determined average value of log 2(T/R) of each clone was used in the examples of the present invention.

Generally, it is difficult to distinguish between three-time amplification (trisomic state) and two-time amplification (disomic state) in the copy number. When a normal DNA is used as the reference DNA, it may be difficult to exactly distinguish the trisomy of Chromosome X in karyotype 47, XXX (super female syndrome) form normal state (karyotype 46, XY). Therefore, it may be preferable to use a DNA sample of Kleinfelter syndrome, karyotype 47, XXY, as a reference, when detecting the copy number aberration in Chromosome X.

The test sample DNA may be extracted from amniotic fluid, peripheral blood, chorionic villus, umbilical cord blood, placenta villi, and cultured cells obtained from a subject. The subject may be a mammalian, preferably human, and more preferably fetus, newborn infants (until 4-weeks after birth) or children.

In yet another embodiment, the present invention provides a kit for diagnosing a disease associated with a chromosomal abnormality, comprising the microarray chip as described above.

In yet another embodiment, the present invention provides a method of diagnosing a disease associated with a chromosomal abnormality using the microarray chip, comprising the steps of:

providing a microarray chip by immobilizing one or more selected from the group consisting of pooled probe sets 1 to 32 in spots on a substrate as described above;

labeling a test sample DNA from a patient and a reference DNA with different labels from each other;

fragmentizing the labeled DNAs, and applying the obtained test sample DNA fragments and the obtained reference DNA fragments onto the spots on the microarray chip, respectively, to hybridize the DNA fragments with the probes;

measuring a signal intensity from each probe hybridized with the test sample DNA or the reference DNA; and

comparing the signal intensity from the test sample DNA over that from the reference DNA, to determine that the patient has a disease associated with a chromosomal abnormality detectable by the used pooled probe set, when a difference is detected between the signal intensity from the test sample DNA and that from the reference DNA.

The test sample DNA may be extracted from amniotic fluid, peripheral blood, chorionic villus, umbilical cord blood, placenta villi, and cultured cells obtained from a patient. The patient may be a mammalian, preferably human, and more preferably fetus, newborns or children.

The disease may be one or more selected from the group consisting of Down syndrome, Patau syndrome, Edward syndrome, Tuner syndrome, Klinefelter syndrome, sex chromosome aneusomies (e.g., super female syndrome, super male syndrome, etc.), most frequently appearing micro-deletion syndromes (e.g., Wolf-Hirschhorn syndrome, Cri-Du-Chat syndrome, William syndrome, Prader-willi syndrome, Miller-Dieker Lissencephaly syndrome, Smith-Magenis syndrome, Digeorge syndrome, Steroid Sulfatase deficiency syndrome, etc.), and the like.

For example, a microarray chip comprising pooled probe set 21 is used and the value of (T/R) corresponding to the pooled probe set 21 immobilized spot is higher than 1, indicating that the subject has Down syndrome.

Therefore, in the kit or the method of the present invention, the microarray chip may comprise

at least pooled probe set 21 for diagnosing Down syndrome;

at least pooled probe set 13 for diagnosing Patau syndrome;

at least pooled probe set 18 for diagnosing Edward syndrome;

at least pooled probe sets 23 and 24 for diagnosing Tuner syndrome, Klinefelter syndrome, Super female syndrome, or Super male syndrome;

at least pooled probe set 25 for diagnosing Wolf-Hirschhorn syndrome;

at least pooled probe set 26 for diagnosing Cri-Du-Chat syndrome;

at least pooled probe set 27 for diagnosing William syndrome;

at least pooled probe set 28 for diagnosing Prader-willi syndrome and/or Angelman syndrome;

at least pooled probe set 29 for diagnosing Miller-Dieker Lissencephaly syndrome;

at least pooled probe set 30 for diagnosing Smith-Magenis syndrome;

at least pooled probe set 31 for diagnosing Digeorge syndrome; or

at least pooled probe set 32 for diagnosing Steroid Sulfatase deficiency syndrome.

Alternatively, the kit or the method of the present invention may use at least one selected from the group consisting of pooled probe sets 13, 18, 21, and 23 to 32 for simultaneously diagnosing at least one selected from the group consisting of Down syndrome, Patau syndrome, Edward syndrome, Tuner syndrome, Klinefelter syndrome, Super female syndrome, Super male syndrome, Wolf-Hirschhorn syndrome, Cri-Du-Chat syndrome, William syndrome, Prader-willi syndrome, Angelman syndrome, Miller-Dieker Lissencephaly syndrome, Smith-Magenis syndrome, Digeorge syndrome, and Steroid Sulfatase deficiency syndrome.

There are several benefits of the diagnosing kit and method, as follows: (1) the results are rapidly available, for example, within 36 hours after the sample collection in the case of amniocentesis, compared to 7-22 days for routine chromosome analysis; not only the most frequently appearing anuesomies, but also the most frequently observed microdeletions in mammalians, especially infants, can be obtain at one time by properly selecting and using the pooled probe sets of the present invention, whereby most time-saving and cost-effective comprehensive prenatal or postnatal evaluations can be achieved; the availability of the results obtained by the present invention along with consistent clinical information (i.e., fetal anomalies detected by karyotyping and ultrasonography) allows for more options that otherwise might not be available; and in the case of a culture failure when standard cytogenetic results are not available, accurate assessment on chromosome copy number for the most frequent aneusomies can be provided. More than two-thirds of all abnormalities can be identified by the present invention at the time of amniocentesis, and at least 90% of clinically significant chromosomal abnormalities detected in live-born infants.

The present invention is further explained in more detail with reference to the following examples. These examples, however, should not be interpreted as limiting the scope of the present invention in any manner.

### Example 1

The following Examples generally refer to Korean Patent Application No. 2004-0066384 and U.S. patent application Ser. No. 11/211,185, which are incorporated herein as references.

### Example 1

### Preparation of KOGENOME 96,768 BAC Clones

1.1. Preparation of Genome Library

A genome was isolated from a Korean man, treated with HindIII enzyme and subjected to PFGE, to obtain a DNA fragment of about 100 Kb. The DNA fragment of the average size of 100 Kb was ligased to a BAC vector, and then, transformed into a host cell, E. coli (Competent cell, E. coli DH10B BAC). Herein, the E. coli cell line containing each DNA fragment was called as a clone, and 96,768 clones in total were obtained through the preparation of genome library.

1.1.1. Isolation of Genome

20 ml of the entire genomic DNA was isolated from semen of a Korean man, and subjected to a qualitative analysis and a quantitative analysis through agarose gel electrophoresis.

1.1.2. Fragmentation and Purification of Genome

The isolated genomic DNA was cleaved with BamHI, and subjected to PEG gel electrophoresis. The portion which was developed at the position of 100 Kb was collected, to isolate DNA fragments.

1.1.3. Transformation

The DNA fragments were inserted into BAC vectors (pECBAC1, Friijter et al. 1997) at BamHI site, and transformed into host cells (Competent cell, E. coli DH10B BAC). Then, the host cells were cultivated in a solid culture media to obtain clone of each cell. The clones were inoculated on 96-well format cell culture blot, and cultivated in a rotating incubator of 300 rpm at 37° C. for 18 hours.

The components of the used solid culture media are as follows:

LB (DIFCO, Cat. No 244620) 25 g

Pancreatic digest of casein 10 g

Yeast extract 5 g

Sodium chloride 10 g

Bacto Agar (DIFCO, Cat. No 214010) 15 g

Chroramphenicol (SIGMA, Cat. No. C0817) 13.6 mg

ddH2O Adjust to 1 L

DIFCO, BD, Sparks. MD21152

SIGMA, ST. louis, MI63178.

1.1.4. Preparation of Library Cell Stock Solution

25 μl of 65% glycerol was put into 384-well plate, and 25 μl of cells cultivated in 96-well format cell culture blot was added thereto (cells cultivated in four 96-well format cell culture blots were collected and stored in one 384-well plate). The top of the 384-well was sealed and stored at −70° C.

1.2. End-Sequencing

500 by of both ends of the 100 Kb DNA fragment were analyzed with a BAC vector specific primer, and the information for the inserted genomic DNA of each clone was confirmed and recorded.

1.2.1. Isolation of BAC DNA (Mini-Prep.)

1×LB 1 ml was put into 96-well culture blot, and library cell stock solution 1 ml was inoculated thereto. The cells stored in one 348-well plate were divisionally cultivated in four 96-well culture blots. The cells was cultivated in a rotating incubator of 300 rpm at 37° C. for 18 hours and, to prepare a sample stock solution in the amount of 25 ml per a well in five times. The remnant was centrifuged at 1000 rpm for 15 minutes, to obtain cells. DNA was collected by using a kit, Montage mini-prep.

1.2.2. Sequencing

Both ends of the DNA fragment inserted into each clone was treated with T7 and M13R primers, and the base sequences thereof were analyzed by using an Automatic DNA Sequencer, ABL 3700.

1.3. Bioinformatics

The analyzed base sequences were subjected to the sequence identity analysis compared with the base sequence of the entire human genome analyzed through the human genome project using a bioinformatics technology. Through the above processes, the position of the BAC DNA in genome of each clone in which the BAC DNA is inserted and the entire base sequence thereof were determined.

A blast search was performed by using the analyzed end sequence, and its position in the genome of each clone was determined by using the sequence identity analysis.

1.4. BAC Clone Identification by FISH

As described above, all of the clones were two end-sequenced using Applied Biosystems 3700 sequencers and their sequences were analyzed by BLAST and mapped according to their positions on the UCSC human genome database (http://www.genome.uscs.edu). Confirmation of locus specificity of about 4,500 clones was performed by removing multiple loci binding clones by individually examining by Fluorescent In Situ Hybridization (FISH). FISH was conducted by using the genomic DNA fragment contained in each BAC clone as a probe. In the FISH technique employing the DNA complementary binding principle, a probe which specifically binds to a specific region of a chromosome is directly bound to the chromosome fixed on a glass slide, to determine the position of the probe in the chromosome.

### Example 2

### Fabrication of Microarray Chip

2.1. Clone selection for Microarray Chip

350 clones shown in Tables 34 are selected for the microarry chip of the present invention as the followings:

(1) From the two end-sequenced and single locus FISH confirmed 4500 clones, 550 clones were chosen as the first set of clones.

(2) Insert size of at least 74-173 kb clones were chosen.

(3) For whole chromosome representing BAC clones, clones were chosen as a 12-15 Mb interval gap between two BAC clones.

(4) For microdeletion representing BAC clones, clones were selected to cover the region at a tiling pathway (i.e., no gap between the two adjacent clones).

(5) Copy Number Variation (CNV, i.e., within a normal human population, some regions of chromosomes are polymorphic) containing BAC clones were removed from the list and the neighboring clones were selected instead to more accurately detect the true copy number aberrations.

In addition, negative controls (non-hybridizing arabidopsis genomic DNA) was included in this chip.

TABLE 34

| | disease | Cyto. | OMIM_ID | gene/marker | clones |
|---|---|---|---|---|---|
| Micro- | ANGELMAN SYNDROME | 15q11-q13 | 105830 | UBE3A | |
| deletion | (same region deletion with PWS) | | | | |
| | CRI-DU-CHAT SYNDROME | 5p15.2 | 123450 | TERT | 7 |
| | DIGEORGE SYNDROME | 22q11.2 | 188400 | TBX1 | 7 |
| | MILLER-DIEKER | 17p13.3 | 247200 | LIS1 | 10 |
| | LISSENCEPHALY | | | | |
| | SYNDROME | | | | |
| | PRADER-WILLI SYNDROME | 15q11-15q13 | 176270 | SNRPN | 10 |
| | SMITH-MAGENIS | 17p11.2 | 182290 | RAI1 | 3 |
| | SYNDROME | | | | |
| | STEROID SULFATASE | Xp22.31 | 308100 | | 3 |
| | DEFICIENCY DISEASE | | | | |
| | WILLIAMS-BEUREN | 7q11.2 | 194050 | LIMK1 | 6 |
| | SYNDROME | | | | |
| | WOLF-HIRSCHHORN | 4p16.3 | 194190 | WHSC1 | 6 |
| | SYNDROME | | | | |
| | SUB TOTAL | | | | 52 |
| Aneuploidy | chromosome1 associated | chromosome1 | | | 19 |
| | chromosome2 associated | chromosome2 | | | 20 |
| | chromosome3 associated | chromosome3 | | | 13 |
| | chromosome4 associated | chromosome4 | | | 15 |
| | chromosome5 associated | chromosome5 | | | 14 |
| | chromosome6 associated | chromosome6 | | | 14 |
| | chromosome7 associated | chromosome7 | | | 13 |
| | chromosome8 associated | chromosome8 | | | 15 |
| | chromosome9 associated | chromosome9 | | | 11 |
| | chromosome10 associated | chromosome10 | | | 13 |
| | chromosome11 associated | chromosome11 | | | 13 |
| | chromosome12 associated | chromosome12 | | | 12 |
| | chromosome13 associated | chromosome13 | | | 9 |
| | chromosome14 associated | chromosome14 | | | 10 |
| | chromosome15 associated | chromosome15 | | | 10 |
| | chromosome16 associated | chromosome16 | | | 9 |
| | chromosome17 associated | chromosome17 | | | 10 |
| | chromosome18 associated | chromosome18 | | | 10 |
| | chromosome19 associated | chromosome19 | | | 10 |
| | chromosome20 associated | chromosome20 | | | 10 |
| | chromosome21 associated | chromosome21 | | | 10 |
| | chromosome22 associated | chromosome22 | | | 10 |
| | chromosomeX associated | chromosomeX | | | 17 |
| | chromosomeY associated | chromosomeY | | | 11 |
| | SUB TOTAL | | | | 298 |
| TOTAL | | | | | 350 |

The clones whose localizations were identified by the above two methods, two end-sequencing and FISH, were used to correctly enumerate copy number of chromosome on which the clones localize. In this fashion, the probes for the entire human chromosomes can be pooled as a 24 set encompassing 1-22 plus X and Y sex chromosomes. In addition, even if the minimal affected regions (MAR) of microdeletions are much smaller, each of the 9 microdeletion syndrome regions is identified and the BAC clone DNAs to represent the region of a syndrome are pooled to detect the specific region of interest. The selected 350 BAC clones (probes) are summarized in Tables 2 to 33 as described above.

2.2. DNA Midi Prep

These 350 clones are extracted 72 clones per day using plasmid midi kit (Qiagen. 12145). After the extraction of DNA, the DNA is digested with Not-1 enzyme for 16 hours and run on a 1% agarose gel to check the purity and concentration. The DNAs are mixed according to chromosome number with same volume per clone. Total 24 kinds of DNA are prepared for the microarray chip.

2.3. Sonication & Condensation

To decrease the viscosity of high molecule DNA and to make the DNA size even about 3 Kbp, 1 ml of each pooled DNA was sonicated (Sonics & Materials, VCX750). After condensation, the pooled DNA was adjusted from 300 ng/μl to 400 ng/μl in 50% DMSO solution and put into 384 plate for spotting.

2.4. Pooling of BAC DNAs and Quality Control

For each pooled DNA to represent either a chromosome or a specific region of a chromosome (i.e., a region to represent a microdeletion syndrome), a list of BAC DNAs was used to combine equal volume of each BAC DNA into a properly labeled tube for a certain chromosome or specific region to be pooled (i.e., label chromosome 1 for chromosome 1 pooled BAC DNAs).

2.5. Confirmation of the Pooled BAC DNA by FISH

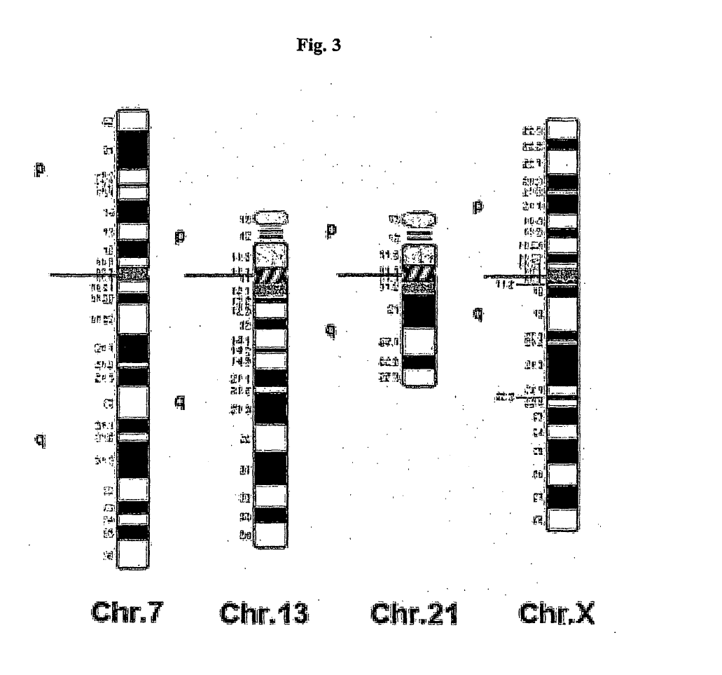

This pooled DNA is further validated before spotting by labeling the DNA for FISH validation. Subsequently, these pooled DNAs were used to validate the correct pooling of each chromosome or a region of chromosome by taking 1 ug of the DNA samples (pooled DNA and control) and labeling them with a green fluorescent dye, to perform FISH experiments as described above. The used pooled DAN and control samples were as shown in Table 35, and the regions used as controls were indicated in FIG. 3 in orange color.

TABLE 35

| Target (pooled DNA) | Control |
|---|---|
| Chr.13 | #626(13q12.1) |
| Chr.13 | Cen.7 |
| Chr.21 | #88(21q11.2) |
| Chr.21 | Cen.7 |
| Chr.X | Cen.X |

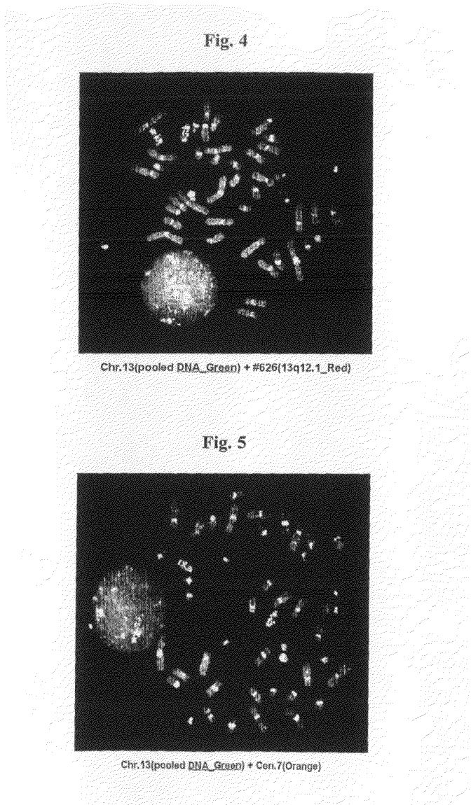

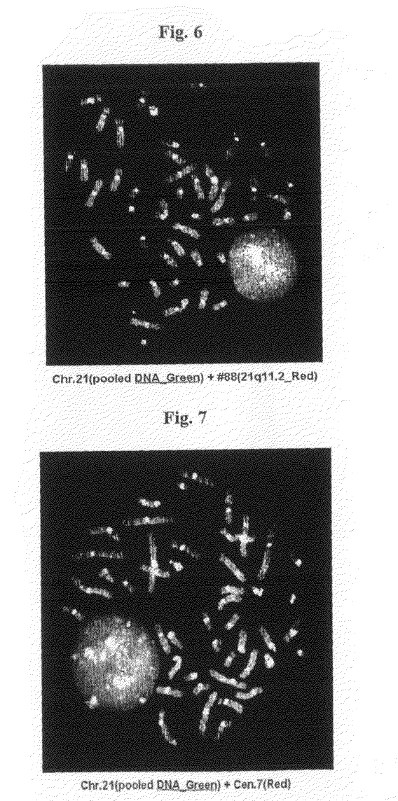

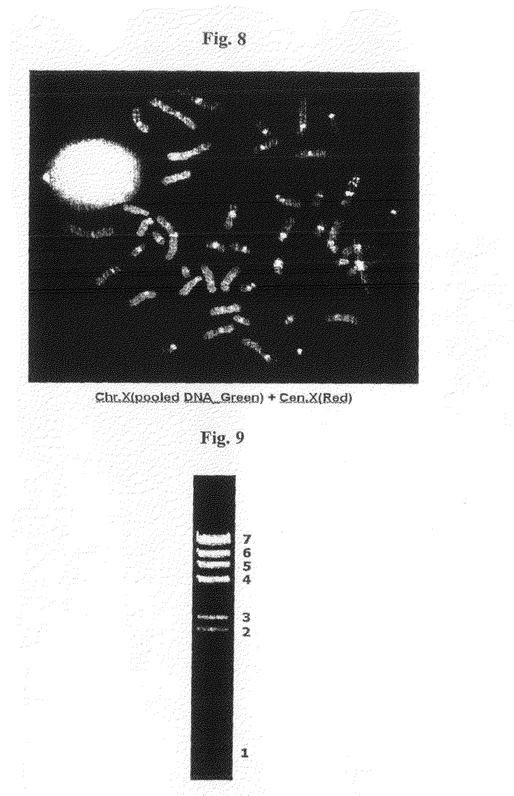

The obtained results were shown in FIGS. 4 to 8.

When each pooled DNA representing a chromosome is properly visualized in 10 independent metaphase spreads, the pooled probe was validated and used in the subsequent A-Chip fabrication. However, any of the pooled DNAs is not qualified, i.e., shows any contaminating chromosomal signals other than the projected chromosome (e.g., pooled 1 chromosome DNA probe binding and showing FISH signal from chromosome X and Y), this pooled DNA will be discarded and a new set of individual BAC DNA is prepared and pooled. This process was repeated until the proper signal was only obtained for the correct chromosome or a region within the chromosome.

2.6. Spotting

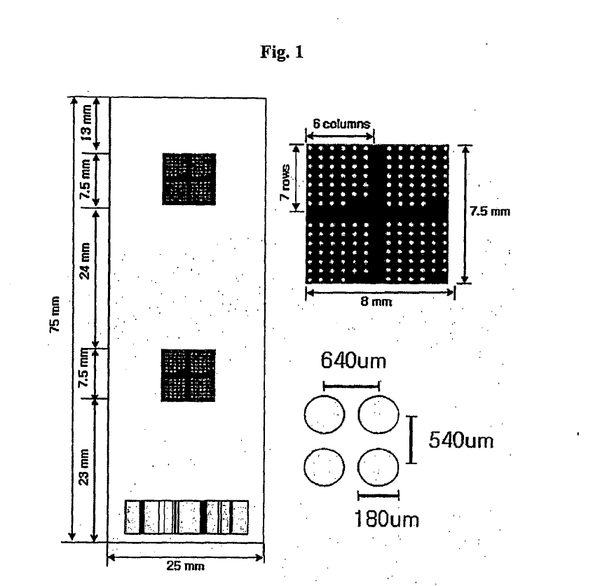

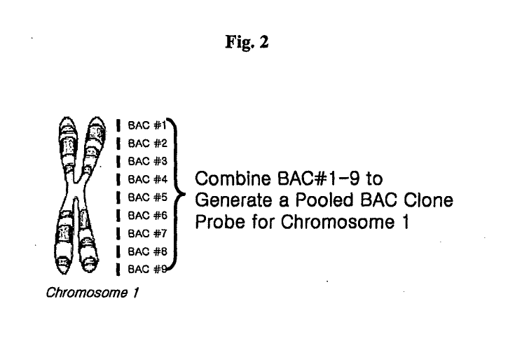

The microarray chip was manufactured by GeneMachine's OmniGrid100 (GeneMachines) using contact pin in controlled temperature of 22-25° C. and humidity of 50%. Each pooling clones were represented on an array as 5 times spots. The fabricated microarray chip was illustrated in FIG. 1. The specification of the microarray chip was summarized in Table 36. The fabricated microarray chip was named as MacArray™ A-Chip. The predecessor of the A-Chip, MacArray™ Karyo1400 utilizing the same technology has been approved by the Korean FDA in March of 2006 as an IVD test.

TABLE 36
5 times spotting
32 pooled clones
For 22 × 22 mm Coverglass & Maui DC Mixer

| Coating | Amino-silanized | |
|---|---|---|
| | Width | 25 ± 0.5 nm |
| Slide size | Length | 75 ± 0.5 nm |
| | Thickness | 1 ± 0.1 nm |
| Spot | Spot area | 8 × 7.5 nm (4 times) |
| | Width space | 0.64 nm |
| | Length space | 0.54 nm |
| | Diameter | 0.18 ± 0.05 nm |
| Subarray # in slide | Columns | 2 |
| | Rows | 2 |
| Spot # in subarray | Columns | 6 |
| | Rows | 7 |

To attach the sonicated DNA on aminosilane coating surface (Corning, UltraGAPS), the microarray were baked in 80° C. for 2 hours and were applied 300 mJ of UV energy. The microarray was kept in desiccator until quality control or packaging.

The performance of used Omnigrid Spotter 100 (GeneMachines) was as follows:

Array run time: Using 48 pins on the optional server arm, 28,416 samples by deposited onto 100 slides in less than 10 hours.

Resolution: X and Y axis: 2.5 μm: Z axis: 1.25 μm

Repeatability: <+/−2.5 μm

Accurarcy: <+/−2.5 μm

2.7. Quality Control (Dye Stain & Hybridization Test)

There are 2 kinds of quality control method for MacArray™ A-Chip. One is dye staining for checking of spot morphology and concentration and the other is Hybridization test for checking the real performance in using normal test and reference genomic DNA. In this example, the Hybridization test was performed by GenePix 4000B (Axon). The GenePix 4000B (Axon) Specification was as follows:

Features 5 μm pixel size

dynamic monitoring of laser power

user-selectable laser power

user-selectable focus position

one-touch calibration and scanner matching

2.8: Prescan of Microarray

All produced microarrays were scanned in 532 nm, 10 micron resolution by the Axon Laser scanner 4000B and the results were saved as JPG images in the hard disk. It is easy to identify the spot shape. If a merged or scratched clones are on a microarray, the microarray are not passed.

2.9: Dye Staining

One slide per lot was stained with dye, like as Topro-3, ToTo-3 of Molecular Probes Inc. After dye staining, the microarray was scanned in 532 nm, 10 micron resolution by the Axon Laser scanner 4000B and the results were saved as JPG images in the hard disk. Clones which is not different from the background intensity was not above 1% in the whole clones.

2.10: Hybridization Test

At least 3 slides in the batches were tested with 10 types standard material genomic DNA and Klinefelter syndrome (karyotype: 47, XXY) genomic DNA. Table 37 shows the 10 types standard materials.

TABLE 37

| | | | Manufacturer* |
|---|---|---|---|
| No. | Syndrome | Karyotype | (Respiratory No.) |
| 1 | Patau syndrome (Female) | 47, XX, +13 | Coriell (AG12070) |
| 2 | Patau syndrome (Male) | 47, XY, +13 | Coriell (GM00526) |
| 3 | Edward syndrome (Female) | 47, XX, +18 | Coriell (GM00143) |
| 4 | Edward syndrome (Male) | 47, XY, +18 | Coriell (GM01359) |
| 5 | Down syndrome (Female) | 47, XX, +21 | Coriell (GM03606) |
| 6 | Down syndrome (Male) | 47, XY, +21 | Coriell (AG05397) |
| 7 | Turner syndrome | 45, XO | Coriell (GM10179) |
| 8 | Klinefelter syndrome | 47, XXY | Coriell (GM03091) |
| 9 | Normal Female | 46, XX | Coriell (GM08400) |
| 10 | Normal Male | 46, XY | Coriell (GM08402) |

*Manufacturer: Coriell Institute for Medical Research, USA

After hybridization test, each sample log 2T/R ratio mean value have to satisfy the criteria values as shown in Table 38. Table 38 shows the criteria values of 10 type standard materials

TABLE 38

| | | | | Chromosome log2 T/R Ratio Mean Value | | | |
|---|---|---|---|---|---|---|---|
| | | | Target | Chromosome 1~22 | | | |
| | | | chrom_{—} | | Except | Sex chromosome | |
| No. | Syndrome | Karyotype | osome | Target | target | X | Y |
| 1 | Patau (Female) | 47, XX, +13 | 13 | M ≧ 0.250 | −0.250 < | −0.250 < | M ≦ −0.400 |
| | | | | | M < 0.250 | M < 0.250 | |
| 2 | Patau (Male) | 47, XY, +13 | | M ≧ 0.250 | −0.250 < | M ≦ −0.250 | −0.400 < |
| | | | | | M < 0.250 | | M < 0.400 |
| 3 | Edward (Female) | 47, XX, +18 | 18 | M ≧ 0.250 | −0.250 < | −0.250 < | M ≦ −0.400 |
| | | | | | M < 0.250 | M < 0.250 | |
| 4 | Edward (Male) | 47, XY, +18 | | M ≧ 0.250 | −0.250 < | M ≦ −0.250 | −0.400 < |
| | | | | | M < 0.250 | | M < 0.400 |
| 5 | Down (Female) | 47, XX, +21 | 21 | M ≧ 0.250 | −0.250 < | −0.250 < | M ≦ −0.400 |
| | | | | | M < 0.250 | M < 0.250 | |
| 6 | Down (Male) | 47, XY, +21 | | M ≧ 0.250 | −0.250 < | M ≦ −0.250 | −0.400 < |
| | | | | | M < 0.250 | | M < 0.400 |
| 7 | Turner | 45, XO | X, Y | — | — | M ≦ −0.250 | M ≦ −0.400 |
| 8 | Klinefelter | 47, XXY | X, Y | — | — | −0.250 < | −0.400 < |
| | | | | | | M < 0.250 | M < 0.400 |
| 9 | Normal (Female) | 46, XX | — | — | −0.250 < | −0.250 < | M ≦ −0.400 |
| | | | | | M < 0.250 | M < 0.250 | |
| 10 | Normal (Male) | 46, XY | — | — | −0.250 < | M ≦ −0.250 | −0.400 < |
| | | | | | M < 0.250 | | M < 0.400 |

* M: Mean value of chromosomal log₂ T/R(Test/Reference) signal ratio

Also the average of log₂T/R ratio SD (Standard Deviation) value from Chromosome 1 to Chromosome 22 clones except target chromosomes (e.g., chromosome 13, 18 or 21) has to be below than 0.08.

### Example 3

### Sample/Specimen Collection

3.1: Pre-Processing of Samples

Before Starting DNA Extraction Pre-Processing

Set a heat block to 55° C.

Reagents: Prepare RBC Lysis Solution (1), Cell Lysis Solution (2), Proteinase K (3).

Reagents 1 and 2 were treated at room temperature, reagent 3 was spun down and put on ice.

Amniotic Fluid Pre-Processing
\textcircled{1} 4 mL of amniotic fluid was put into a 15 mL conical tube and centrifuge at 1,500 rpm for 5 minutes at room temperature (RT).
\textcircled{2} The top layer 3.5 mL was pipetted out and the bottom layer was vortexed for 10 seconds.
\textcircled{3} 0.5 mL vortexed solution was transferred into a 1.5 mL eppendorf tube and centrifuged at 13,000 rpm for 1 minute at RT.
\textcircled{4} The supernatant was removed and while leaving just a cell pellet.
\textcircled{5} 600 μL Cell Lysis Solution was added and vortexed for 5 seconds.
\textcircled{6} The tube into was put a heat block at 55° C. 15 minutes.
\textcircled{7} The obtained reaction mixture was cooled down at RT for 5 minutes before extracting DNA.

Chorionic Villi Pre-Processing
\textcircled{1} 5 mL PBS was put into two petri dishes.
\textcircled{2} Blood was removed from the sample by washing consecutively in the two petri dishes.
\textcircled{3} The sample was put into a new petri dish and dissected out the decidua under a dissecting microscope.
\textcircled{4} The sample was transferred into a new petri dish and diced into 2 mm blocks.
\textcircled{5} The diced samples were put into a 1.5 mL eppendorf tube and 600 μL of Cell Lysis Solution, and 84 of Proteinase K were added thereto.
\textcircled{6} The obtained reaction mixture was put into a 55° C. heat block for two hours and vortexed for 5 seconds in every 30 minutes.
\textcircled{7} The obtained reaction mixture was cooled down at RT for 5 minutes before extracting DNA.

Cord Blood and Peripheral Blood Pre-Processing
\textcircled{1} 300 μL of blood was put into a 1.5 mL eppendorf tube, 900 μL of RBC Lysis Solution was added, and vortexed for 10 seconds.
\textcircled{2} The reaction mixture was stored at RT for 5 minutes and spun at 13,000 rpm for 1 minute.
\textcircled{3} The supernatant was removed and while leaving just a cell pellet.
\textcircled{4} 600 μL Cell Lysis Solution was added and vortex for 5 seconds.
\textcircled{5} The tube was put into a heat block at 55° C. 15 minutes.
\textcircled{6} The reaction mixture was cooled down at RT for 5 minutes before extracting DNA.

Placenta Villi Pre-Processing
\textcircled{1} 5 mL PBS was put into two petri dishes.
\textcircled{2} Blood was removed from the sample by washing consecutively in the two petri dishes.
\textcircled{3} The sample was transferred into a new petri dish and diced into 2 mm blocks.
\textcircled{4} The diced samples were put into a 1.5 mL eppendorf tube and put 600 μL of Cell Lysis Solution, 8 μL of Proteinase K.
\textcircled{5} The reaction mixture was put into a 55° C. heat block for two hours and vortex for 5 seconds in every 30 minutes.
\textcircled{6} The reaction mixture was cooled down at RT for 5 minutes before extracting DNA.

Tissue Culture Cells Pre-Processing
\textcircled{1}15 μL (3×10⁶ Cells) of culture cells was put into a 1.5 mL eppendorf tube and 600 μL of Cell Lysis Solution and 8 μL of Proteinase K were added thereto.
\textcircled{2} The reaction mixture was put into a 55° C. heat block for two hours and vortex for 5 seconds in every 30 minutes.
\textcircled{3} The reaction mixture was cooled down at RT for 5 minutes before extracting DNA.

3.2. DNA Extraction Processing Protocols

Before Starting DNA Extraction Processing

Set a heat block to 55° C.

Reagents: Glycogen solution (4), RNase A (5), Protein Precipitation Solution (6), DNA Hydration Solution (7)

Spin down reagents 4, 5, 6, & 7 and store at RT.

Protocol
\textcircled{1} Add 2 μL of RNase A into the pre-processed sample containing tube and vortex for 10 seconds.
\textcircled{2} Digest for 15 minutes at a 37° C. incubator.
\textcircled{3} Add 150 μL of Protein Precipitation Solution.
\textcircled{4} Vortex for 10 seconds and store on ice for 5 minutes.
\textcircled{5} Centrifuge for 4 minutes at 13,000 rpm at RT and take about 700 μL of the supernatant into a new 1.5 mL eppendorf tube.
\textcircled{6} Add 600 μL of Isopropanol and 1 μL Glycogen solution and votex for 3 seconds.
\textcircled{7} Remove the supernatant by spinning at 13,000 rpm for 10 minutes at RT and add 150 uL of 70% ethanol.
\textcircled{8} Spin at 13,000 rpm for 5 minutes at RT and remove the supernatant.
\textcircled{9} Dry at RT for 10 minutes.
\textcircled{10} Add 1004 of DNA Hydration Solution (except for the DNA from amniotic fluids, put 25 μL of DNA Hydration Solution).
   \textcircled{11} Set a heat block to 55° C.
   \textcircled{12} Vortex for 3 seconds and store at −20° C.

3.3. Quality Control of Extracted DNA

Before Starting the DNA Quality Check

2×DNA Loading Dye Preparation: Mix sterile 200 μL ddH2O and 100 μ 6×DNA Loading Dye in a 1.5 mL eppendorf tube and votex for 3 seconds and spin down briefly.

50 ng/μl λHindIII Marker Preparation: Mix 50 μL of 6×DNA Loading Dye and 30 μL of 500 ng/μL λHindIII Marker in 250 μL sterile ddH2O in a 1.5 mL.

(1) Agarose Gel Electrophoresis
\textcircled{1} Agarose powder was melted by microwaving in 1×TAE Buffer to make 1% Agarose gel.
   A. DNA extracted from Blood (Cord and Periperal blood), Tissue (Corionic and Placental villi) and tissue culture cells: Mix, in a 1.5 mL eppendorf tube, 10 μL extracted DNA and 90 μL sterile ddH2O, then vortex for 3 seconds and spin down. 4 μL of this diluted DNA solution is mixed with 4 μL of 2×DNA Loading Dye.
   B. DNA extracted from amniotic fluid: Mix 4 μL of DNA straight with 4 μL of 2×DNA Loading Dye.
\textcircled{2} 1% Agarose gel was put into a gel chamber with 1×TAE Buffer.
\textcircled{3} 4 μL of 50 ng/μL λHindIII Marker, 8 μL of 2×DNA Loading Dye plus DNA was loaded on a separate well.
\textcircled{4} The 2×DNA Loading Dye 30 mm was run and the gel electrophoris was completed.
\textcircled{5} The 1% Agarose gel was converted into a Gel image analyzer and some images were captured.

(2) λHindIII Marker Separation in 1% Agarose Gel

The obtained results were summarized in Table 39 and FIG. 9.

TABLE 39

| Band No. | Concentration(approx.) | Size (kb) |
|---|---|---|
| 7 | 25.0 ng/μl | 23.0 |
| 6 | 10.0 ng/μl | 9.4 |
| 5 | 7.0 ng/μl | 6.5 |

| | |
|---|---|
| 4 | N/A |

| | | |
|---|---|---|
| 3 | 2.5 ng/μl | 2.3 |
| 2 | 2.2 ng/μl | 2.0 |
| 1 | 0.5 ng/μl | 0.5 |

(3) Measure DNA Concentration Using UV/Spectrophotometric Detector.

The measurement was performed according to the manufacturer's protocol, but briefly, the extracted DNA was diluted in ddH2O and Optical Density (OD) was measured at 260 and 280 nm wavelength.

### Example 3

### DNA Detection

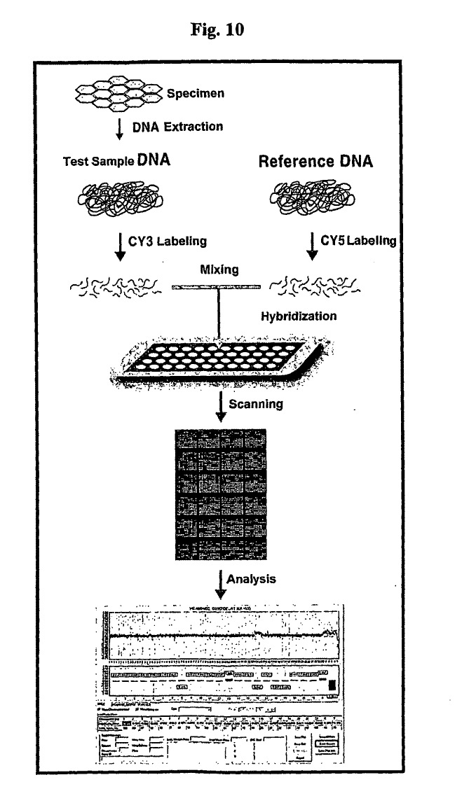

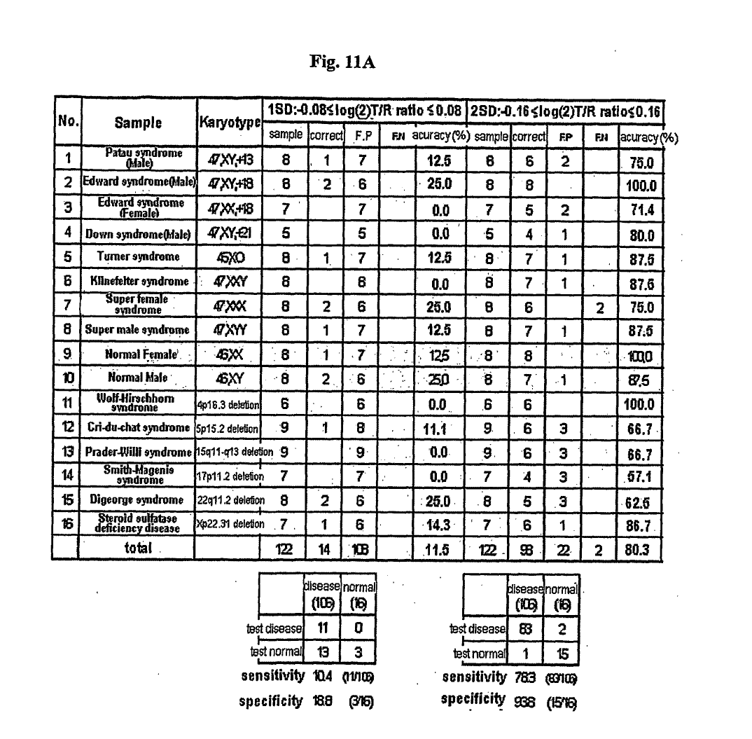

The following detection processes were schematically shown in FIG. 10.

3.1. Prepare Genomic DNA from the Samples

The sample DNA was collected in the amount of 50 ng from the amniotic sample, and 500 ng from the rest of test samples.

The used test samples were summarized in Tables 40 and 41.

TABLE 40

| | | | Manufacturer* |
|---|---|---|---|
| No. | Syndrome | Karyotype | (Repository No.) |
| 1 | Patau syndrome (Male) | 47, XY, +13 | Coriell (NA02948) |
| 2 | Edward syndrome (Male) | 47, XY, +18 | Coriell (NA01359) |
| 3 | Edward syndrome | 47, XX, +18 | Coriell (GM00143) |
| | (Female) | | |
| 4 | Down syndrome (Male) | 47, XY, +21 | Coriell (NA01921) |
| 5 | Turner syndrome | 45, XO | Coriell (GM00857) |
| 6 | Klinefelter syndrome | 47, XXY | Coriell (GM03091) |
| 7 | Super female syndrome | 47, XXX | Coriell (NA04626) |
| 8 | Super male syndrome | 47, XYY | Coriell (GM02587) |
| 9 | Normal Female | 46, XX | Coriell (GM08400) |
| 10 | Normal Male | 46, XY | Coriell (GM08402) |
| 11 | Wolf-Hirschhorn | 4p16.3 deletion | Coriell (GM00343) |
| | syndrome | | |
| 12 | Cri-du-chat syndrome | 5p15.2 deletion | Coriell (NA14124) |
| 13 | Prader-Willi syndrome | 15q11-q13 | Coriell (NA11382) |
| | | deletion | |
| 14 | Smith-Magenis syndrome | 17p11.2 deletion | Coriell (GM13476) |
| 15 | Digeorge syndrome | 22q11.2 deletion | Coriell (NA07215) |
| 16 | Steroid sulfatase | Xp22.31 deletion | Coriell (GM03035) |
| | deficiency disease | | |

TABLE 41

| | | | Number | Number of | Number |
|---|---|---|---|---|---|
| | | | of | Correct | of Mis- |
| | | | Samples | Karyo- | karyo- |
| No | Sample | Karyotype | tested | typing | typing |
| 1 | Patau syndrome | 47, XY, +13 | 8 | 8 | 0 |
| | (Male) | | | | |
| 2 | Edward syndrome | 47, XY, +18 | 8 | 8 | 0 |
| | (Male) | | | | |
| 3 | Edward syndrome | 47, XX, +18 | 7 | 7 | 0 |
| | (Female) | | | | |
| 4 | Down syndrome | 47, XY, +21 | 5 | 5 | 0 |
| | (Male) | | | | |
| 5 | Turner syndrome | 45, XO | 8 | 8 | 0 |
| 6 | Klinefelter | 47, XXY | 8 | 8 | 0 |
| | syndrome | | | | |
| 7 | Super female | 47, XXX | 8 | 8 | 0 |
| | syndrome | | | | |
| 8 | Super male | 47, XYY | 8 | 8 | 0 |
| | syndrome | | | | |
| 9 | Normal Female | 46, XX | 8 | 8 | 0 |
| 10 | Normal Male | 46, XY | 8 | 8 | 0 |
| 11 | Wolf-Hirschhorn | 4p16.3 | 6 | 6 | 0 |
| | syndrome | deletion | | | |
| 12 | Cri-du-chat | 5p15.2 | 9 | 9 | 0 |
| | syndrome | deletion | | | |
| 13 | Prader-Willi | 15q11-q13 | 9 | 9 | 0 |
| | syndrome | deletion | | | |
| 14 | Smith-Magenis | 17p11.2 | 7 | 7 | 0 |
| | syndrome | deletion | | | |
| 15 | Digeorge | 22q11.2 | 8 | 8 | 0 |
| | syndrome | deletion | | | |
| 16 | Steroid sulfatase | Xp22.31 | 7 | 7 | 0 |
| | deficiency | deletion | | | |
| | total | | 122 | 122 | 0 |

3.2. DNA Labeling with Fluorescent Dyes

Sample DNA 50 ng or 500 ng+1 mM Cy3 3 μL

Reference DNA 50 ng or 500 ng+1 mM Cy5 3 μL

Temperature: 37° C.

Reaction Time: 16 hours (or overnight)

After reaction labeled DNA amount was equaled or more than 4 μg.

3.3. Hybridization

Cy3-Sample DNA and Cy5-Reference DNA were mixed. The obtained mixture was applied onto the Macrogen A-Chip fabricated above and then covered with a coverglass, to allow hybridization.

Temperature: 37±1° C., humidity 90±5%

Reaction time: 16 hours (or Overnight)

3.4. Washing

Wash 1: 50% Formamide, 2×SSC, 46° C., 15 minutes (min.)

Wash 2: 2×SSC, 0.1% SDS, 46° C., 30 min.

Wash 3: 1×Phosphate Buffer, 0.1% Nonidet P40, RT, 15 min.

Wash 4: 2×SSC, RT, 5 min.

Wash 5: 70%, 85%, 100% ethanol, RT

Dry Spin: 1,500 rpm, RT, 5 min.

3.5. Scanning & Image Analysis

Refer to cutoff table for scanning time.

Refer to MacArray A-Chip manual for image analysis protocols

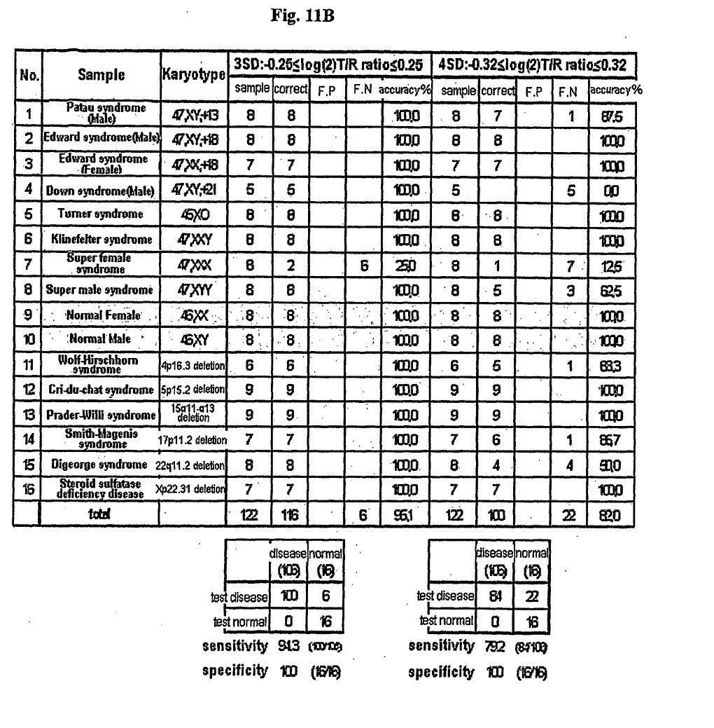

The obtained results were shown in Tables 42 and 43, and FIGS. 11A and 11B.

TABLE 42

| | | | | | chr1~chr22 | | | | | |
|---|---|---|---|---|---|---|---|---|---|---|
| | | | Target | | (except target) | | chrX | | chrY | |
| | | | | STD | | STD | | STD | | STD |
| No | Sample | Karyotype | AVG | EV | AVG | EV | AVG | EV | AVG | EV |
| 1 | Patau (Male) | 47, XY, +13 | 0.398 | 0.032 | 0.001 | 0.034 | — | — | — | — |
| 2 | Edward (Male) | 47, XY, +18 | 0.461 | 0.052 | 0.001 | 0.040 | — | — | — | — |
| 3 | Edward (Female) | 47, XX, +18 | 0.420 | 0.039 | 0.000 | 0.037 | — | — | — | — |
| 4 | Down (Male) | 47, XY, +21 | 0.290 | 0.027 | 0.004 | 0.043 | — | — | — | — |
| 5 | Turner | 45, XO | — | — | 0.004 | 0.040 | −0.449 | 0.102 | −0.574 | 0.201 |
| 6 | Klinefelter | 47, XXY | — | — | 0.004 | 0.034 | −0.024 | 0.015 | −0.003 | 0.015 |
| 7 | Super female | 47, XXX | — | — | 0.004 | 0.040 | 0.336 | 0.053 | −0.488 | 0.174 |
| 8 | Super male | 47, XYY | — | — | −0.001 | 0.046 | −0.473 | 0.087 | 0.360 | 0.071 |
| 9 | Normal Female | 46, XX | — | — | 0.004 | 0.031 | 0.004 | 0.027 | −0.556 | 0.082 |
| 10 | Normal Male | 46, XY | — | — | 0.001 | 0.036 | −0.516 | 0.065 | −0.017 | 0.041 |
| 11 | Wolf-Hirschhorn | 4p16.3 del | −0.447 | 0.123 | 0.001 | 0.036 | — | — | — | — |
| 12 | Cri-du-chat | 5p15.2 del | −0.495 | 0.110 | −0.003 | 0.047 | — | — | — | — |
| 13 | Prader-Willi | 15q11-q13 del | −0.525 | 0.062 | 0.001 | 0.037 | — | — | — | — |
| 14 | Smith-Magenis | 17p11.2 del | −0.390 | 0.063 | −0.001 | 0.033 | — | — | — | — |
| 15 | Digeorge | 22q11.2 del | −0.330 | 0.052 | 0.004 | 0.037 | — | — | — | — |
| 16 | Steroid sulfatase | Xp22.31 del | −1.145 | 0.179 | 0.001 | 0.040 | — | — | — | — |
| | deficiency | | | | | | | | | |

TABLE 43

| | | | | Chromosome log2 T/R Ratio Mean Value | | | |
|---|---|---|---|---|---|---|---|
| | | | Target | Chromosome 1~22 | | | |
| | | | chromo- | | Except | Sex chromosome | |
| No | Syndrome | Karyotype | some | Target | target | X | Y |
| 1 | Patau (Male) | 47, XY, +13 | 13 | M ≧ 0.250 | −0.250 < | M ≦ −0.250 | −0.400 < |
| | | | | | M < 0.250 | | M < 0.400 |
| 2 | Edward (Male) | 47, XY, +18 | 18 | M ≧ 0.250 | −0.250 < | M ≦ −0.250 | −0.400 < |
| | | | | | M < 0.250 | | M < 0.400 |
| 3 | Edward (Female) | 47, XX, +18 | | M ≧ 0.250 | −0.250 < | −0.250 < | M ≦ −0.400 |
| | | | | | M < 0.250 | M < 0.250 | |
| 4 | Down (Male) | 47, XY, +21 | | M ≧ 0.250 | −0.250 < | M ≦ −0.250 | −0.400 < |
| | | | | | M < 0.250 | | M < 0.400 |
| 5 | Turner | 45, XO | X, Y | — | — | M ≦ −0.250 | M ≦ −0.400 |
| 6 | Klinefelter | 47, XXY | X, Y | — | — | −0.250 < | −0.400 < |
| | | | | | | M < 0.250 | M < 0.400 |
| 7 | Super Female | 47, XXX | X, Y | — | — | M ≦ −0.250 | M ≦ −0.400 |
| 8 | Super Male | 47, XYY | X, Y | — | — | −0.250 < | −0.400 < |
| | | | | | | M < 0.250 | M < 0.400 |
| 9 | Normal (Female) | 46, XX | — | — | −0.250 < | −0.250 < | M ≦ −0.400 |
| | | | | | M < 0.250 | M < 0.250 | |
| 10 | Normal (Male) | 46, XY | — | — | −0.250 < | M ≦ −0.250 | −0.400 < |
| | | | | | M < 0.250 | | M < 0.400 |
| 11 | Wolf-Hirschhorn | 4p16.3 del | 4p16.3 | M ≦ −0.250 | −0.250 < | — | — |
| | | | | | M < 0.250 | | |
| 12 | Cri-du-chat | 5p15.2 del | 5p15.2 | M ≦ −0.250 | −0.250 < | — | — |
| | | | | | M < 0.250 | | |
| 13 | Prader-Willi | 15q11-q13 del | 15q11-q13 | M ≦ −0.250 | −0.250 < | — | — |
| | | | | | M < 0.250 | | |
| 14 | Smith-Magenis | 17p11.2 del | 17p11.2 | M ≦ −0.250 | −0.250 < | — | — |
| | | | | | M < 0.250 | | |
| 15 | Digeorge | 22q11.2 del | 22q11.2 | M ≦ −0.250- | −0.250 < | — | — |
| | | | | | M < 0.250 | | |
| 16 | Steroid sulfatase | Xp22.31 del | Xp22.31 | M ≦ −0.800- | −0.250 < | — | — |
| | deficiency | | | | M < 0.250 | | |

What is claimed is:

1. A microarray chip for detecting human chromosomal abnormality, comprising one or more pooled probe sets immobilized in spots on a substrate, wherein the pooled probe set is one or more selected from the group consisting of:
a pooled probe set (pooled probe set 1) specific to the chromosomal abnormality in copy number of Chromosome 1 consisting essentially of human chromosomal polynucleotides carried in BAC27_N16, BAC25_C19, BAC153_I07, BAC217_C19, BAC59_D13, BAC54_I02, BAC163_C09, BAC218_G03, BAC152_F22, BAC34_P03, BAC36_I16, BAC145_L11, BAC37_O23, BAC239_G19, BAC105_P13, BAC57_N17, BAC239_A12, BAC171_H09, and BAC222_E02;
a pooled probe set (pooled probe set 2) specific to the chromosomal abnormality in copy number of Chromosome 2 consisting essentially of human chromosomal polynucleotides carried in BAC126_E04, BAC197_E10, BAC43_A02, BAC33_C05, BAC59_D21, BAC12_G01, BAC141_F07, BAC163_C22, BAC36_H22, BAC143_G24, BAC238_G01, BAC252_A16, BAC46_J12, BAC57_C12, BAC34_F17, BAC79_L21, BAC39_M07, BAC156_K09, BAC195_I06, and BAC88_K20;
a pooled probe set (pooled probe set 3) specific to the chromosomal abnormality in copy number of Chromosome 3 consisting essentially of human chromosomal polynucleotides carried in BAC197_B21, BAC158_C03, BAC144_C11, BAC186_N05, BAC103_F06, BAC114_B23, BAC102_E23, BAC119_G21, BAC68_H20, BAC237_M11, BAC168_G04, BAC61_M02, and BAC36_N19;
a pooled probe set (pooled probe set 4) specific to the chromosomal abnormality in copy number of Chromosome 4 consisting essentially of human chromosomal polynucleotides carried in BAC60_H08, BAC26_C10, BAC68_{—O}19, BAC102_G08, BAC127_B16, BAC176_G14, BAC41_{—O}05, BAC37_H04, BAC115_C13, BAC30_N21, BAC220_D24, BAC106_P17, BAC41_O11, BAC157_P10, and BAC27_L15;
a pooled probe set (pooled probe set 5) specific to the chromosomal abnormality in copy number of Chromosome 5 consisting essentially of human chromosomal polynucleotides carried in BAC86_B20, BAC33_N18, BAC55_L24, BAC226_H03, BAC156_E24, BAC237_B02, BAC29_D17, BAC139_M23, BAC21_J16, BAC27_N23, BAC148_D23, BAC186_L21, BAC238_E21, and BAC175_N07;
a pooled probe set (pooled probe set 6) specific to the chromosomal abnormality in copy number of Chromosome 6 consisting essentially of human chromosomal polynucleotides carried in BAC125_G09, BAC182_E20, BAC81_C08, BAC24_P12, BAC76_A23, BAC26_F16, BAC43_M14, BAC27_P17, BAC1_N23, BAC247_D17, BAC101_M04, BAC90_F08, BAC118_M18, and BAC179_N12;
a pooled probe set (pooled probe set 7) specific to the chromosomal abnormality in copy number of Chromosome 7 consisting essentially of human chromosomal polynucleotides carried in BAC231_L03, BAC82_L17, BAC218_N01, BAC5_A09, BAC170_M16, BAC119_K16, BAC248_P06, BAC96_F02, BAC139_J04, BAC76_K13, BAC192_N04, BAC154_A21, and BAC120_I09;
a pooled probe set (pooled probe set 8) specific to the chromosomal abnormality in copy number of Chromosome 8 consisting essentially of human chromosomal polynucleotides carried in BAC150_M15, BAC149_J08, BAC63_M21, BAC147_O15, BAC44_I16, BAC30_N24, BAC43_J01, BAC234_M17, BAC68_K11, BAC200_C08, BAC237_M08, BAC61_N10, BAC80_H19, BAC150_P12, and BAC66_I02;
a pooled probe set (pooled probe set 9) specific to the chromosomal abnormality in copy number of Chromosome 9 consisting essentially of human chromosomal polynucleotides carried in BAC80_F23, BAC28_L14, BAC137_L16, BAC161_C10, BAC92_D01, BAC163_H11, BAC12_E22, BAC172_D10, BAC149_L08, BAC188_O18, and BAC126_N07;
a pooled probe set (pooled probe set 10) specific to the chromosomal abnormality in copy number of Chromosome 10 consisting essentially of human chromosomal polynucleotides carried in BAC170_F05, BAC102_J19, BAC40_P04, BAC141_E23, BAC246_I22, BAC14_K16, BAC52_B14, BAC158_C10, BAC155_O18, BAC144_E19, BAC218_E11, BAC48_I12, and BAC182_N07;
a pooled probe set (pooled probe set 11) specific to the chromosomal abnormality in copy number of Chromosome 11 consisting essentially of human chromosomal polynucleotides carried in BAC68_K10, BAC90_E18, BAC24_K17, BAC58_O19, BAC36_K05, BAC150_P20, BAC154_H22, BAC26_C09, BAC119_O13, BAC195_O14, BAC73_E17, BAC 142_K09, and BAC65_D19;
a pooled probe set (pooled probe set 12) specific to the chromosomal abnormality in copy number of Chromosome 12 consisting essentially of human chromosomal polynucleotides carried in BAC60_I23, BAC121_P21, BAC199_G02, BAC65_G10, BAC41_I18, BAC10_M07, BAC39_O14, BAC144_K11, BAC178_M15, BAC134_M17, BAC65_I21, and BAC27_E08;
a pooled probe set specific (pooled probe set 13) to the chromosomal abnormality in copy number of Chromosome 13 consisting essentially of human chromosomal polynucleotides carried in BAC28_H21, BAC163_F01, BAC78_C21, BAC135_O03, BAC237_P24, BAC84_N09, BAC8_C18, BAC133_G23, and BAC116_B15;
a pooled probe set (pooled probe set 14) specific to the chromosomal abnormality in copy number of Chromosome 14 consisting essentially of human chromosomal polynucleotides carried in BAC236_F24, BAC22_E01, BAC37_K09, BAC79_J20, BAC50_I09, BAC15_E12, BAC63_O11, BAC11_N10, BAC39_P02, and BAC101_O15;
a pooled probe set (pooled probe set 15) specific to the chromosomal abnormality in copy number of Chromosome 15 consisting essentially of human chromosomal polynucleotides carried in BAC66_K21, BAC162_K11, BAC178_K16, BAC21_K13, BAC167_M02, BAC88_F18, BAC168_F12, BAC10_E08, BAC177_H09, and BAC41_K03;
a pooled probe set (pooled probe set 16) specific to the chromosomal abnormality in copy number of Chromosome 16 consisting essentially of human chromosomal polynucleotides carried in BAC38_I04, BAC96_J19, BAC120_K24, BAC177_P23, BAC247_B03, BAC117_H14, BAC96_G02, BAC24_D17, and BAC223_D19;
a pooled probe set (pooled probe set 17) specific to the chromosomal abnormality in copy number of Chromosome 17 consisting essentially of human chromosomal polynucleotides carried in BAC200_M05, BAC50_A03, BAC149_H11, BAC29_G13, BAC238_E06, BAC150_O15, BAC70_P11, BAC70_N11, BAC116_E10, and BAC48_K14;
a pooled probe set (pooled probe set 18) specific to the chromosomal abnormality in copy number of Chromosome 18 consisting essentially of human chromosomal polynucleotides carried in BAC57_H08, BAC141_I04, BAC252_H16, BAC232_E19, BAC149_I18, BAC186_P19, BAC 151_L02, BAC230_C11, BAC43_A24, and BAC184_J04;
a pooled probe set (pooled probe set 19) specific to the chromosomal abnormality in copy number of Chromosome 19 consisting essentially of human chromosomal polynucleotides carried in BAC178_L22, BAC160_C11, BAC131_N13, BAC54_N22, BAC233_K14, BAC162_K04, BAC76_E22, BAC211_B15, BAC101_H02, and BAC193_C07;
a pooled probe set (pooled probe set 20) specific to the chromosomal abnormality in copy number of Chromosome 20 consisting essentially of human chromosomal polynucleotides carried in BAC247_K09, BAC26_J24, BAC75_H16, BAC37_M13, BAC19_G17, BAC82_B07, BAC96_H08, BAC166_J02, BAC41_E11, and BAC146_N07;
a pooled probe set (pooled probe set 21) specific to the chromosomal abnormality in copy number of Chromosome 21 consisting essentially of human chromosomal polynucleotides carried in BAC102_F10, BAC240_M07, BAC200_O02, BAC97_O19, BAC119_K07, BAC200_A23, BAC221_D22, BAC100_D11, BAC33_D15, and BAC126_M10;
a pooled probe set (pooled probe set 22) specific to the chromosomal abnormality in copy number of Chromosome 22 consisting essentially of human chromosomal polynucleotides carried in BAC169_G07, BAC153_I19, BAC100_P10, BAC37_J03, BAC187_K08, BAC131_H09, BAC106_C07, BAC66_M06, BAC51_M21, and BAC153_O04;
a pooled probe set (pooled probe set 23) specific to the chromosomal abnormality in copy number of Chromosome X consisting essentially of human chromosomal polynucleotides carried in BAC70_N16, BAC22_H14, BAC65_L14, BAC151_A03, BAC49_G05, BAC130_K20, BAC103_N15, BAC136_M01, BAC6_B17, BAC141_P03, BAC246_K02, BAC91_J24, BAC97_C11, BAC63_G23, BAC73_B07, BAC162_B10, and BAC119_C15;
a pooled probe set (pooled probe set 24) specific to the chromosomal abnormality in copy number of Chromosome Y consisting essentially of human chromosomal polynucleotides carried in BAC24_K23, BAC205_L13, BAC127_H21, BAC192_M14, BAC101_I21, BAC140_H17, BAC65_J16, BAC180_K16, BAC102_F03, BAC31_L01, and BAC240_H05;
a pooled probe set (pooled probe set 25) specific to micro-deletion of 4p16.3 of Chromosome 4 consisting essentially of human chromosomal polynucleotides carried in BAC50_H08, BAC67_I12, BAC100_E03, BAC1_F06, BAC135_O20, and BAC153_J14;
a pooled probe set (pooled probe set 26) specific to micro-deletion of 5p15.2 of Chromosome 5 consisting essentially of human chromosomal polynucleotides carried in BAC143_N22, BAC206_I13, BAC252_N08, BAC64_P22, BAC208_N21, BAC200_E05, and BAC240_K06;
a pooled probe set (pooled probe set 27) specific to micro-deletion of 7q11.2 of Chromosome 7 consisting essentially of human chromosomal polynucleotides carried in BAC69_O08, BAC66_N22, BAC180_N24, BAC67_C05, BAC183_A12, and BAC123_D05;
a pooled probe set (pooled probe set 28) specific to micro-deletion of 15q11-15q13 of Chromosome 15 consisting essentially of human chromosomal polynucleotides carried in BAC188_N24, BAC223_H02, BAC217_F02, BAC71_A18, BAC5_L18, BAC248_C13, BAC78_F07, BAC180_J22, BAC21_O06, and BAC105_L07;
a pooled probe set (pooled probe set 29) specific to micro-deletion of 17p13.3 of Chromosome 17 consisting essentially of human chromosomal polynucleotides carried in BAC95_J10, BAC75_C17, BAC110_O13, BAC63_J08, BAC190_F10, BAC186_M15, BAC183_M06, BAC135_N07, BAC148_F06, and BAC31_H03;
a pooled probe set (pooled probe set 30) specific to micro-deletion of 17p11.2 of Chromosome 17 consisting essentially of human chromosomal polynucleotides carried in BAC249_G12, BAC41_D18, and BAC186_E14;
a pooled probe set (pooled probe set 31) specific to micro-deletion of 22q11.2 of Chromosome 22 consisting essentially of human chromosomal polynucleotides carried in BAC124_E21, BAC196_A22, BAC69_P21, BAC141_K20, BAC169_K21, BAC145_P12, and BAC224_F10; and
a pooled probe set (pooled probe set 32) specific to micro-deletion of Xp22.31 of Chromosome X consisting essentially of human chromosomal polynucleotides carried in BAC221_A12, BAC191_E24, and BAC231_F19.

2. The microarray chip according to claim 1, comprising one or more selected form the group consisting of pooled probe sets 1 to 24 to detect chromosomal abnormality in copy number of Chromosomes 1 to 22, X and Y corresponding to the used pooled probe set.

3. The microarray chip according to claim 1, comprising one or more selected form the group consisting of pooled probe sets 25 to 32 to detect micro-deletion of specific chromosomal regions corresponding to the used pooled probe set.

4. The microarray chip according to claim 2, further comprising one or more selected form the group consisting of pooled probe sets 25 to 32, to simultaneously detect chromosomal abnormality in copy number of Chromosomes 1 to 22, X and Y, and micro-deletion of specific chromosomal regions corresponding to the used pooled probe sets.

5. The microarray chip according to claim 1, comprising all pooled probe sets 1 to 32, to simultaneously detect chromosomal abnormality in copy number of Chromosomes 1 to 22, X and Y, and micro-deletion of specific chromosomal regions.

6. A method of preparing the microarray chip according to claim 1, comprising the step of immobilizing one or more selected from the group consisting of pooled probe sets 1 to 32 in spots on a substrate, wherein all probes belonging to only a pooled probe set are immobilized in one spot, one spot comprises only one pooled probe set, and the microarray chip comprises at least one spot for each pooled probe set.

7. A method of detecting chromosomal abnormalities, comprising the steps of:
providing the microarray chip according to claim 1;
labeling a test sample DNA and a reference DNA with different labels from each other;
fragmentizing the labeled DNAs, and applying the obtained test sample and reference DNA fragments onto the spots on the microarray chip, respectively, to hybridize the DNA fragments with the probes in the spot;
measuring a signal intensity from each pooled probe set hybridized with the test sample DNA or the reference DNA; and
comparing the signal intensity from the test sample DNA over that from the reference DNA.

8. The method according to claim 7, wherein the microarray chip comprises one or more selected form the group consisting of pooled probe sets 1 to 24, to detect chromosomal abnormality in copy number of Chromosomes 1 to 22, X and Y corresponding to the used pooled probe set.

9. The method according to claim 7, wherein the microarray chip comprises one or more selected form the group consisting of pooled probe sets 25 to 32 to detect micro-deletion of specific chromosomal regions corresponding to the used pooled probe set.

10. The method according to claim 9, wherein the microarray chip further comprises one or more selected form the group consisting of pooled probe sets 25 to 32, to simultaneously detect chromosomal abnormality in copy number of Chromosomes 1 to 22, X and Y, and micro-deletion of specific chromosomal regions corresponding to the used pooled probe sets.

11. The method according to claim 7, wherein the microarray chip comprises all pooled probe sets I to 32, to simultaneously detect chromosomal abnormality in copy number of Chromosomes 1 to 22, X and Y, and micro-deletion of specific chromosomal regions.

12. The method according to claim 7, wherein the test sample DNA was extracted from amniotic fluid, peripheral blood, chorionic villus, umbilical cord blood, placenta villi, and cultured cells obtained from human.

13. A kit for diagnosing a disease associated with a chromosomal abnormality, comprising the microarray chip according to claim 1.

14. The kit according to claim 13, wherein the microarray chip comprises one or more selected from the group consisting of:
pooled probe set 13 for diagnosing Patau syndrome;
pooled probe set 18 for diagnosing Edward syndrome;
pooled probe set 21 for diagnosing Down syndrome;
pooled probe sets 23 and 24 for diagnosing Tuner syndrome, Klinefelter syndrome, Super female syndrome, or Super male syndrome;
pooled probe set 25 for diagnosing Wolf-Hirschhorn syndrome;
pooled probe set 26 for diagnosing Cri-Du-Chat syndrome;
pooled probe set 27 for diagnosing William syndrome;
pooled probe set 28 for diagnosing Prader-willi syndrome or Angelman syndrome;
pooled probe set 29 for diagnosing Miller-Dieker Lissencephaly syndrome;
pooled probe set 30 for diagnosing Smith-Magenis syndrome;
pooled probe set 31 for diagnosing Digeorge syndrome; and
pooled probe set 32 for diagnosing Steroid Sulfatase deficiency syndrome.

15. The kit according to claim 14, wherein the microarray chip comprises of pooled probe sets 13, 18, 21, and 23 to 32 for simultaneously diagnosing Down syndrome, Patau syndrome, Edward syndrome, Tuner syndrome, Klinefelter syndrome, Super female syndrome, Super male syndrome, Wolf-Hirschhorn syndrome, Cri-Du-Chat syndrome, William syndrome, Prader-willi syndrome, Angelman syndrome, Miller-Dieker Lissencephaly syndrome, Smith-Magenis syndrome, Digeorge syndrome, and Steroid Sulfatase deficiency syndrome.

16. A method of diagnosing a disease associated with a chromosomal abnormality, comprising the steps of
providing a microarray chip according to claim 1;
labeling a test sample DNA from a patient and a reference DNA with different labels from each other;
fragmentizing the labeled DNAs, and applying the obtained test sample and reference DNA fragments onto the spots on the microarray chip, respectively, to hybridize the DNA fragments with the probes;
measuring a signal intensity from each probe hybridized with the test sample DNA or the reference DNA; and
comparing the signal intensity from the test sample DNA over that from the reference DNA, to determine that the patient has a disease associated with a chromosomal abnormality detectable by the used pooled probe set, when a difference is detected between the signal intensity from the test sample DNA and that from the reference DNA.

17. The method according to claim 16, wherein the microarray chip comprises one or more selected from the group consisting of:
pooled probe set 13 for diagnosing Patau syndrome;
pooled probe set 18 for diagnosing Edward syndrome;
pooled probe set 21 for diagnosing Down syndrome;
pooled probe sets 23 and 24 for diagnosing Tuner syndrome, Klinefelter syndrome, Super female syndrome, or Super male syndrome;
pooled probe set 25 for diagnosing Wolf-Hirschhorn syndrome;
pooled probe set 26 for diagnosing Cri-Du-Chat syndrome;
pooled probe set 27 for diagnosing William syndrome;
pooled probe set 28 for diagnosing Prader-willi syndromev or Angelamn syndrome;
pooled probe set 29 for diagnosing Miller-Dieker Lissencephaly syndrome;
pooled probe set 30 for diagnosing Smith-Magenis syndrome;
pooled probe set 31 for diagnosing Digeorge syndrome; and
pooled probe set 32 for diagnosing Steroid Sulfatase deficiency syndrome.

18. The method according to claim 14, wherein the microarray chip comprises of pooled probe sets 13, 18, 21, and 23 to 32, to simultaneously diagnose Down syndrome, Patau syndrome, Edward syndrome, Tuner syndrome, Klinefelter syndrome, Super female syndrome, Super male syndrome, Wolf-Hirschhorn syndrome, Cri-Du-Chat syndrome, William syndrome, Prader-willi syndrome, Angelman syndrome, Miller-Dieker Lissencephaly syndrome, Smith-Magenis syndrome, Digeorge syndrome, and Steroid Sulfatase deficiency syndrome.
